(19) United States
(12) Patent Application Publication
(10) Pub. No.: US 2026/0299447 A1
(43) Pub. Date: Oct. 1, 2026

(54) TONER

(71) Applicant: CANON KABUSHIKI KAISHA, Tokyo (JP)

(72) Inventors: KAHO YAMADA, Shizuoka (JP); KENJI AOKI, Shizuoka (JP); SHUHEI IWASAKI, Kanagawa (JP); YUHEI TERUI, Shizuoka (JP); TATSUYA SAEKI, Shizuoka (JP)

(21) Appl. No.: 19/576,392

(22) Filed: Mar. 24, 2026

(30) Foreign Application Priority Data
Mar. 28, 2025 (JP) 2025-055528

(51) Int. Cl. G03G 9/087; G03G 9/093

(52) U.S. Cl. CPC G03G 9/08724; G03G 9/09328

(57) ABSTRACT

A toner is provided, containing a toner particle having a binder resin which contains a crystalline resin and an amorphous resin, wherein the number-average particle diameter of the toner is within a specific range, the crystalline resin contains a crystalline vinyl resin having a specific monomer unit, and a melting point peak derived from the crystalline vinyl resin is observed within a specific range in DSC measurement. Cross-sectionional observation of the toner reveals a phase separation structure having a crystalline phase mainly of the crystalline resin and an amorphous phase mainly of the amorphous resin is present therein, the amorphous phase occupies at least 15% of the cross-sectionional area, and the crystalline and the amorphous phase are present in a specific relationship in a region A up to 500 nm inward from the toner particle surface and in a region B other than the region A.

### BACKGROUND

### Field of the Technology

The present disclosure relates to a toner for use in electrophotography and electrostatic recording methods.

### Description of the Related Art

Conventionally, energy saving has been considered a major technical challenge in electrophotographic devices, and significant reductions in the amount of heat applied to a fixing device have been considered. For toners, there is a growing need for so-called “low-temperature fixability”, which allows fixing at low energy.

As a method for enabling fixing at a low temperature, the use of crystalline resins as binder resins has been considered. Amorphous resins, which are commonly used as binder resins for toners, do not show a clear endothermic peak in differential scanning calorimetry (DSC) measurements, whereas in crystalline resins, an endothermic peak (melting point) appears in DSC measurements.

Crystalline resins have the property of hardly softening at temperatures below the melting point thereof due to the regular arrangement of molecular chains. Furthermore, when the temperature exceeds the melting point, the crystals melt rapidly, resulting in a rapid decrease in viscosity. Such crystalline resins, which exhibit excellent sharp melt property, are attracting attention as useful materials for improving the low-temperature fixability of toners.

There is a toner using crystalline vinyl resins having long-chain alkyl groups in side chains in the molecule as crystalline resins. Typically, crystalline vinyl resins have a structure in which long-chain alkyl groups are bonded as side chains to the main chain, and the crystallization of these long-chain alkyl groups forms the crystalline resin.

Japanese Patent Laid-Open No. 2014-142632 discloses a toner exhibiting a sea-island structure composed of a sea portion mainly composed of a crystalline vinyl resin and island portions mainly composed of an amorphous resin.

Japanese Patent Laid-Open No. 2020-173414 discloses atoner using a crystalline vinyl resin obtained by copolymerizing a polymerizable monomer having a long-chain alkyl group and an amorphous polymerizable monomer with a different SP value.

### SUMMARY

However, it has been found that the low-temperature fixability of the toner described in Japanese Patent Laid-Open No. 2014-142632 decreases when printing on rough paper under conditions with a large amount of toner laid thereon in a low-temperature environment. This is believed to be due to the presence of a large amount of amorphous resin in the region close to the surface inside the toner particle.

Rough paper is paper with large surface irregularities; the protrusions of the paper easily receive heat from a heater, while the recesses are unlikely to receive heat from the heater. On cold rough paper in a low-temperature environment, the toner laid in the recesses only receives heat on the surface. Because there is a large amount of amorphous resin that is difficult to melt in the region close to the surface inside the toner particle, this is disadvantageous for adhesion between toner particles, and it is believed that a phenomenon called “blank dots”, where some of the toner falls off the image, occurs.

In a toner described in Japanese Patent Laid-Open No. 2020-173414, the above problem is unlikely to occur because a large amount of crystalline resin is present in the region close to the surface inside the toner particle. However, it has been found that when printing on rough paper, density unevenness (hereinafter referred to as mottling) occurs. This is believed to be due to the fact that the entire toner is composed of crystalline vinyl resin. The toner on the protrusions, where the heat from the heater is easily transmitted, has a significantly lower viscosity because the entire toner is crystalline vinyl resin, and penetration thereof into the paper is facilitated. This is thought to result in a lower density compared to the recesses of the paper, thereby causing mottling.

The present disclosure provides a toner that exhibits excellent low-temperature fixability on rough paper under conditions with a large amount of toner laid thereon in a low-temperature environment, and furthermore, is less prone to mottling on rough paper.

The present disclosure relates to a toner including a toner particle containing a binder resin, wherein the binder resin includes a crystalline resin and an amorphous resin; the toner has a number-average particle diameter of 4.0 μm to 10.0 μm; the crystalline resin contains a crystalline vinyl resin having a monomer unit (a) represented by a following formula (1); in differential scanning calorimetry (DSC) using the toner as a sample, a melting point peak derived from the crystalline vinyl resin is observed in a range of 50.0° C. to 80.0° C.; and when a cross-section of the toner is observed by using a scanning transmission electron microscope, (i) the cross-section of the toner particle has a phase separation structure including a crystalline phase mainly composed of the crystalline resin and an amorphous phase mainly composed of the amorphous resin, and a proportion of an area of the amorphous phase in the cross-section of the toner particle is at least 15.0% by area; and (ii) when a region from the toner particle surface to 500 nm inward of the toner particle is defined as region A, and a region other than the region A is defined as region B, a proportion of an area of the crystalline phase in the region A is at least 60.0% by area, and a proportion of the area of the amorphous phase in the region B is 1.5 times or more the proportion of the area of the amorphous phase in the region A:

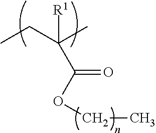

[In formula (1), R¹ represents a hydrogen atom or a methyl group, and n represents an integer 15 to 35.]

Features of the present disclosure will become apparent from the following description of embodiments with reference to the attached drawing. The following description of embodiments is described by way of example.

### BRIEF DESCRIPTION OF THE DRAWING

The FIGURE is an example of a 256-level brightness histogram obtained from a cross-sectional image of the toner.

### DESCRIPTION OF THE EMBODIMENTS

In the present disclosure, unless otherwise specified, the expressions “from XX to YY” or “XX to YY” representing a numerical range refer to a numerical range that includes both the lower and upper limits. When a numerical range is stated in stages, the upper and lower limits of each numerical range can be arbitrarily combined. Furthermore, in the present disclosure, a statement such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. When XX is a group, multiple members may be selected from XX, and the same applies to YY and ZZ.

(Meth)acrylic acid ester refers to acrylic acid ester and/or methacrylic acid ester.

“Monomer unit” refers to the reacted form of a monomer substance in a polymer. For example, in the main chain of a polymer formed by polymerization of a polymerizable monomer, one carbon-carbon bond section is considered one unit. The polymerizable monomer can be represented by the following formula (C).

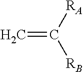

[In formula (C), R_{A} represents a hydrogen atom or an alkyl group (preferably an alkyl group having 1 to 3 carbon atoms, more preferably a methyl group), and RB represents a freely selected substituent.]

A crystalline resin refers to a resin that shows a clear endothermic peak in differential scanning calorimetry (DSC) measurement.

Generally, crystalline vinyl resins have a faster melting rate compared to amorphous resins. Therefore, the presence of crystalline vinyl resin in the region near the surface of the toner particle, where heat is easily transferred during fixing, facilitates adhesion between toner particles. As a result, even under conditions where the toner laid-on level on rough paper is large in a low-temperature environment, and heat is unlikely to be transferred to the toner present in the recesses of the paper, blank dots are less likely to occur, and good low-temperature fixability is easily achieved.

On the other hand, since crystalline vinyl resin forms a structure with a regular arrangement at the molecular level, when the resin melts due to the temperature increase during fixing, the viscosity thereof tends to decrease more easily compared to an amorphous resin. When printing on rough paper, the viscosity of the toner laid on the protrusions of the paper decreases significantly, making it easier for the toner to penetrate into the paper. This creates a difference in density with the recesses of the paper where the toner has not penetrated into the paper, and mottling is likely to occur.

The present inventors have found that the above problems can be solved by appropriately controlling the proportion of a crystalline phase mainly composed of a crystalline vinyl resin in a region near the surface of the toner particle, and the proportion of an amorphous phase mainly composed of an amorphous resin in a region away from the surface.

The present disclosure relates to a toner comprising a toner particle containing a binder resin, wherein
the binder resin includes a crystalline resin and an amorphous resin;
the toner has a number-average particle diameter of 4.0 μm to 10.0 μm;
the crystalline resin contains a crystalline vinyl resin having a monomer unit (a) represented by a following formula (1);
in differential scanning calorimetry (DSC) using the toner as a sample, a melting point peak derived from the crystalline vinyl resin is observed in a range of 50.0° C. to 80.0° C.; and
when a cross-section of the toner is observed by using a scanning transmission electron microscope,
(i) the cross-section of the toner particle has a phase separation structure comprising a crystalline phase mainly composed of the crystalline resin and an amorphous phase mainly composed of the amorphous resin, and
the proportion of an area of the amorphous phase in the cross-section of the toner particle is 15.0% by area or more; and
(ii) when a region from the toner particle surface to 500 nm inward the toner particle is defined as region A, and a region other than the region A is defined as region B,
the proportion of an area of the crystalline phase in the region A is 60.0% by area or more, and
the proportion of the area of the amorphous phase in the region B is 1.5 times or more the proportion of the area of the amorphous phase in the region A.

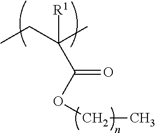

[In formula (1), R¹ represents a hydrogen atom or a methyl group, and n represents an integer of 15 to 35.]

The toner of the present disclosure has a toner particle containing a binder resin, wherein the binder resin contains a crystalline resin and an amorphous resin. The crystalline resin contains a crystalline vinyl resin having a monomer unit (a) represented by the following formula (1).

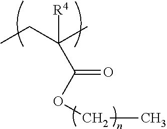

In formula (1), R¹ represents a hydrogen atom or a methyl group, and n represents an integer of 15 to 35.

The monomer unit (a) has a long-chain alkyl group. The presence of the monomer unit (a) in the vinyl resin makes it a crystalline vinyl resin. The fact that n in formula (1) is 15 to 35 facilitates the expression of crystallinity in the crystalline vinyl resin. n is preferably an integer of 17 to 29.

The number-average particle diameter of the toner is 4.0 μm to 10.0 μm. Having a number-average particle diameter within this range ensures excellent low-temperature fixability even under conditions where the toner laid-on level on rough paper is large in a low-temperature environment, and also reduces mottling on rough paper. The number-average particle diameter of the toner is preferably 4.5 μm to 9.0 μm, and more preferably 5.0 μm to 8.0 μm.

Furthermore, in differential scanning calorimetry (DSC) using the toner as a sample, a melting point peak derived from the crystalline vinyl resin is observed in the range of 50.0° C. to 80.0° C. Having the melting point peak within this range results in good low-temperature fixability. The melting point peak lower than 50.0° C. is advantageous for low-temperature fixability, but the crystalline vinyl resin begins melting even during high-temperature storage of the toner, significantly reducing heat-resistant storage stability. If the melting point peak is higher than 80.0° C., excellent performance in terms of heat-resistant storage stability is demonstrated, but low-temperature fixability decreases.

The melting point peak derived from the crystalline vinyl resin is preferably observed in a range of 55.0° C. to 75.0° C., more preferably 60.0° C. to 70.0° C. This melting point peak can be controlled by the content ratio of the monomer unit (a) represented by formula (1) in the crystalline vinyl resin, the chain length n of the monomer unit (a), etc.

Furthermore, when a cross-section of the toner is observed by using a scanning transmission electron microscope,

(i) the cross-section of the toner particle has a phase separation structure comprising a crystalline phase mainly composed of the crystalline resin and an amorphous phase mainly composed of the amorphous resin.

The presence of the phase separation structure having a crystalline phase mainly composed of the crystalline resin and an amorphous phase mainly composed of the amorphous resin in the cross-section of the toner particle ensures excellent low-temperature fixability.

The proportion of the area of the amorphous phase in the cross-section of the toner particle is 15.0% by area or more.

Where the proportion of the area of the amorphous phase is within the above range, a certain amount of amorphous resin with a relatively high viscosity during melting is present, so that even in a toner particle on the protrusion of rough paper where the temperature is likely to rise during fixing, the toner does not penetrate too deeply into the paper, and mottling can be suppressed. Where the proportion of the area of the amorphous phase in the cross-section of the toner particle is less than 15.0% by area, the toner particle contains a small amount of the amorphous resin with a relatively high viscosity, and mottling occurs.

The proportion of the amorphous phase present in the toner particle cross-section can be controlled by the type and amount added of the amorphous resin used.

Although there is no particular upper limit, the preferred range for the proportion of the area of the amorphous phase in the cross-section is 15.0% by area to 80.0% by area, more preferably 15.0% by area to 60.0% by area, and even more preferably 25.0% by area to 60.0% by area.

Furthermore, when a cross-section of the toner is observed by using a scanning transmission electron microscope,
(ii) when a region from the toner particle surface to 500 nm inward the toner particle is defined as region A, and a region other than the region A is defined as region B,
the proportion of the area of the crystalline phase in the region A is 60.0% by area or more.

Region A is from the contour of the toner particle cross-section to 500 nm towards the center of the toner particle. Region A represents “a region close to the surface within the toner particle,” and the fact that the proportion of the area of the crystalline phase in region A is within the above range indicates that a certain amount of crystalline vinyl resin with a relatively fast melting rate is present near the surface. Therefore, when printing on rough paper under conditions where the toner laid-on level is large in a low-temperature environment, the surface of toner present in the recesses of the paper also melts easily, and sufficient adhesion between toner particles is achieved, resulting in good low-temperature fixability. If the proportion of the area of the crystalline phase in region A is less than 60.0% by area, the adhesion between toner particles present in the recesses of the paper becomes unfavorable, and blank dots occur during low-temperature fixing.

The proportion of the area of the crystalline phase in region A can be controlled by the type and amount added of crystalline vinyl resin used, the type and amount added of shell resin used in the case of toner produced by the suspension polymerization method, and the timing of adding the crystalline vinyl resin during toner production in the case of toner produced by the emulsion aggregation method.

The proportion of the area of the crystalline phase in region A can be increased, for example, by increasing the amount of crystalline vinyl resin added, or, in the emulsion aggregation method, by delaying the timing of adding the crystalline vinyl resin compared to the timing of adding the amorphous resin. Conversely, the proportion of the area of the crystalline phase in region A can be decreased, for example, by decreasing the amount of crystalline vinyl resin added, or, in the emulsion aggregation method, by adding the crystalline vinyl resin earlier than the amorphous resin.

The preferred range for the proportion of the area of the crystalline phase in region A is 70.0% by area or more, and more preferably 80.0% by area or more. The proportion of the area of the crystalline phase in region A is, for example, 60.0% by area to 99.0% by area, preferably 70.0% by area to 98.0% by area, and more preferably 80.0% by area to 97.5% by area.

Furthermore, in the cross-sectional observation of the toner using a scanning transmission electron microscope, the proportion of the area of the amorphous phase in region B needs to be 1.5 times or more the proportion of the area of the amorphous phase in region A. That is, the ratio of the proportion of the area of the amorphous phase in region B to the proportion of the area of the amorphous phase in region A [(proportion of the area of amorphous phase in region B)/(proportion of the area of amorphous phase in region A)] is 1.5 or more.

Region B represents “the region inside the toner particle that is away from the surface”, and the fact that the [(proportion of the area of amorphous phase in region B)/(the proportion of the area of amorphous phase in region A)] is 1.5 or more indicates that a certain amount of amorphous resin with a relatively high viscosity during melting is present in the region away from the surface. Therefore, the toner present on the protrusions of rough paper where the temperature is likely to rise during fixing does not penetrate too deeply into the paper, and mottling can be suppressed. Where the [(proportion of the area of amorphous phase in region B)/(proportion of the area of amorphous phase in region A)] is less than 1.5, the amount of the amorphous resin with a relatively high viscosity is small in the region away from the surface inside the toner particles, and mottling occurs.

The proportion of the amorphous phase present in the cross-section can be controlled by the type and amount added of amorphous resin used, the type and amount added of shell resin used in the case of toner produced by suspension polymerization method, and the timing of adding the amorphous resin during toner production in the case of toner produced by the emulsion aggregation method.

The [(proportion of the area of amorphous phase in region B)/(proportion of the area of amorphous phase in region A)] can be easily increased by, for example, increasing the amount added of amorphous resin for the shell, or by adding the amorphous resin earlier than the crystalline vinyl resin in the emulsion aggregation method. Conversely, the [(proportion of the area of amorphous phase in region B)/(proportion of the area of amorphous phase in region A)] can be easily decreased by, for example, decreasing the amount added of amorphous resin for the shell, or by adding the amorphous resin later than the crystalline vinyl resin in the emulsion aggregation method.

The proportion of the area of the amorphous phase in region B is, for example, 1.5 times to 15.0 times, preferably 2.0 times to 12.0 times, more preferably 2.5 times to 11.0 times, and even more preferably 3.5 times to 10.5 times the proportion of the area of the amorphous phase in region A.

A crystalline resin will now be described. The binder resin contains a crystalline resin. The crystalline resin contains a crystalline vinyl resin, but may also contain a crystalline polyester resin, a crystalline polyurethane resin, a crystalline epoxy resin, etc.

A crystalline vinyl resin is described hereinbelow.

A method for introducing the monomer unit (a) into the crystalline vinyl resin can be exemplified by the following method of polymerizing a (meth)acrylic acid ester. For example, stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dodriacontyl (meth)acrylate, and 2-decyltetradecyl (meth)acrylate can be mentioned.

One type of the monomer unit (a) of formula (1) may be used alone or a combination of two or more types may be used. The crystalline vinyl resin may have other units in addition to the monomer unit (a). A method for introducing other units into the crystalline vinyl resin can be exemplified by a method of polymerizing a (meth)acrylic acid ester capable of forming the monomer unit (a) with another vinyl monomer.

Examples of other vinyl monomers include the following.

Styrene, α-methylstyrene, and (meth)acrylic acid esters such as, methyl (meth)acrylate, ethyl (meth)acrylate, n-butyl (meth)acrylate, t-butyl (meth)acrylate, 2-ethylhexyl (meth)acrylate, and lauryl (meth)acrylate.

Monomers having a nitrile group: for example, acrylonitrile and methacrylonitrile.

Monomers having a urea group: for example, monomers obtained by reacting an amine having 3 to 22 carbon atoms [primary amines (such as n-butylamine, t-butylamine, propylamine, and isopropylamine), secondary amines (such as di-n-ethylamine, di-n-propylamine, and di-n-butylamine), aniline, cyclohexylamine, etc.] with an isocyanate having 2 to 30 carbon atoms and an ethylenically unsaturated bond by a known method.

Monomers having a carboxyl group; for example, methacrylic acid, acrylic acid, (meth)acrylic acid-2-carboxyethyl.

Monomers having a hydroxyl group; for example, (meth)acrylic acid-2-hydroxyethyl, (meth)acrylic acid-2-hydroxypropyl, etc.

Monomers having an amide group; for example, acrylamide, and monomers obtained by reacting an amine having 1 to 30 carbon atoms with a carboxylic acid having 2 to 30 carbon atoms and an ethylenically unsaturated bond (such as acrylic acid and methacrylic acid) by a known method.

Monomers having a lactam structure; for example, N-vinyl-2-pyrrolidone.

Among these, it is preferable to use at least one selected from the group consisting of acrylonitrile and methacrylonitrile, which are monomers having a nitrile group, and N-vinyl-2-pyrrolidone, which is a monomer having a lactam structure. That is, the crystalline vinyl resin preferably has a monomer unit derived from at least one monomer selected from the group consisting of acrylonitrile, methacrylonitrile, and N-vinyl-2-pyrrolidone. More preferably, the crystalline vinyl resin has a monomer unit derived from at least one monomer selected from the group consisting of acrylonitrile and methacrylonitrile (even more preferably acrylonitrile). The nitrile group and lactam structure have high affinity for paper and easily improve the adhesion between toner and paper. Therefore, low-temperature fixability is likely to be improved.

The content ratio of the monomer unit (a) in the crystalline vinyl resin is preferably 20.0% by mass to 90.0% by mass, more preferably 25.0% by mass to 85.0% by mass, and even more preferably 40.0% by mass to 80.0% by mass. Within these ranges, a better balance between low-temperature fixability and heat-resistant storage stability is achieved.

The crystalline vinyl resin preferably contains 1.0% by mass to 25.0% by mass, more preferably 3.0% by mass to 20.0% by mass, of a monomer unit derived from at least one selected from the group consisting of acrylonitrile, methacrylonitrile, and N-vinyl-2-pyrrolidone (even more preferably acrylonitrile).

The crystalline vinyl resin preferably contains 5.0% by mass to 40.0% by mass, more preferably 10.0% by mass to 30.0% by mass, of a monomer unit derived from styrene.

The crystalline vinyl resin preferably contains 1.0% by mass to 20.0% by mass, more preferably 2.0% by mass to 10.0% by mass, of a monomer unit derived from n-butyl (meth)acrylate.

The crystalline vinyl resin can be obtained, for example, by copolymerizing a (meth)acrylic acid ester for introducing the above-mentioned monomer unit (a) and other vinyl monomer. The obtained crystalline vinyl resin can be used as a precursor, and other vinyl monomers can be further reacted therewith through a hydrogen abstraction reaction.

The hydrogen abstraction reaction is a reaction that generates a radical by abstracting a hydrogen atom bonded to a carbon atom, and other vinyl monomer can be further reacted from the generated radical. This allows the monomer units (a) in the crystalline vinyl resin to form a more aggregated state within the molecule, making it easier to enhance crystallinity.

The weight-average molecular weight (Mw) of the tetrahydrofuran (THF)-soluble component of the crystalline vinyl resin, as measured by gel permeation chromatography (GPC), is preferably, for example, from 25,000 to 300,000, and more preferably from 30,000 to 300,000. Having Mw in this range makes it easier to adjust the melting point of the crystalline vinyl resin to an appropriate range for exhibiting low-temperature fixability. Mw is more preferably from 40,000 to 250,000, and even more preferably from 60,000 to 200,000.

The storage elastic modulus of the crystalline vinyl resin at 80° C. is preferably 1.0×10³ Pa to 1.0×10⁶ Pa. Within this range, the viscosity during fixing tends to be good, and low-temperature fixability is likely to be improved. The storage elastic modulus of the crystalline vinyl resin at 80° C. is more preferably 2.0×10³ Pa to 1.0×10⁶ Pa, and even more preferably 3.0×10³ Pa to 8.0×10⁵ Pa.

The content ratio of the crystalline vinyl resin in the binder resin is, for example, 5.0% by mass to 77.0% by mass, preferably 5.0% by mass to 70.0% by mass, more preferably 10.0% by mass to 70.0% by mass, even more preferably 15.0% by mass to 65.0% by mass, and still more preferably 20.0% by mass to 65.0% by mass. Within these ranges, low-temperature fixability is likely to be improved even under conditions where the toner laid-on level on rough paper is large in a low-temperature environment, and mottling is less likely to occur when printing on rough paper.

The amorphous resin will now be described. The binder resin contains an amorphous resin. Examples of amorphous resins include amorphous vinyl resins, amorphous polyester resins, amorphous polyurethane resins, and amorphous epoxy resins. The amorphous resin includes, for example, at least one selected from the group consisting of amorphous vinyl resins and amorphous polyester resins. It is preferable that the amorphous resin includes an amorphous vinyl resin. It is also preferable that the amorphous resin includes an amorphous polyester resin. It is even more preferable that the amorphous resin includes both an amorphous vinyl resin and an amorphous polyester resin.

The vinyl monomers that can be used in the above-described crystalline vinyl resin can also be used in the amorphous vinyl resin. As long as the amorphous vinyl resin does not exhibit crystallinity, (meth)acrylic acid esters for introducing the monomer unit (a) can also be used.

Furthermore, so-called crosslinking agents containing a plurality of vinyl groups per monomer can also be used. Examples of crosslinking agents include the following. Diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl) propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, 2,2′-bis(4-(methacryloxypolyethoxy)phenyl)propane, trimethylolpropane trimethacrylate, tetramethylolmethane tetramethacrylate, divinylbenzene, divinylnaphthalene, divinyl ether, and 4,4′-divinylbiphenyl.

The content ratio of amorphous vinyl resin in the amorphous resin is, for example, 43.0% by mass or more, preferably 50.0% by mass or more, and more preferably 70.0% by mass or more. Within these ranges, a network of amorphous vinyl resin is easily formed during fixing, making it easier to suppress the occurrence of mottling.

The content ratio of amorphous vinyl resin in the amorphous resin is, for example, 43.0% by mass to 98.0% by mass, preferably 50.0% by mass to 95.0% by mass, and more preferably 70.0% by mass to 95.0% by mass.

Furthermore, the content ratio of amorphous vinyl resin in the binder resin is, for example, 10.0% by mass to 80.0% by mass, preferably 10.0% by mass to 75.0% by mass, more preferably 20.0% by mass to 75.0% by mass, and even more preferably 30.0% by mass to 75.0% by mass. Within these ranges, a network of amorphous vinyl resin is easily formed in the fixed image, making it easier to suppress the occurrence of mottling.

The amorphous resin preferably contains an amorphous polyester resin in addition to the amorphous vinyl resin.

As the amorphous polyester resin, an amorphous polyester resin obtained by the reaction of a monovalent or divalent or higher carboxylic acid and a monohydric or dihydric or higher alcohol can be used. The amorphous polyester resin is preferably a condensation polymer of a monovalent or divalent carboxylic acid and a monohydric or dihydric alcohol, and more preferably a condensation polymer of a divalent carboxylic acid and a dihydric alcohol. The amorphous polyester resin obtained by this reaction makes it easier to adjust the crystalline phase and amorphous phase of regions A and B to appropriate ranges.

Examples of polycarboxylic acids include the following compounds.

Dibasic acids such as succinic acid, adipic acid, sebacic acid, phthalic acid, isophthalic acid, terephthalic acid, malonic acid, and dodecenylsuccinic acid, and anhydrides thereof or lower alkyl esters thereof, aliphatic unsaturated dicarboxylic acids such as maleic acid, fumaric acid, itaconic acid, and citraconic acid; trimellitic acid and anhydride thereof, trimesic acid, pyromellitic acid, naphthalenetricarboxylic acid, or lower alkyl esters thereof, etc.

One type of these may be used individually or two or more types may be used in combination.

Isophthalic acid and dodecenylsuccinic acid are preferred as the polycarboxylic acid.

Examples of polyhydric alcohols include the following compounds.

Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. The alkyl portions of the alkylene glycols and alkylene ether glycols may be linear or branched. Furthermore, glycerin, trimethylolethane, trimethylolpropane, and pentaerythritol can also be used. One type of these may be used individually or two or more types may be used in combination.

The polyhydric alcohol is preferably a 1 mole to 5 mole adduct of bisphenol A with an alkylene oxide (ethylene oxide and/or propylene oxide).

For the purpose of adjusting the acid value and hydroxyl value, monovalent acids such as acetic acid and benzoic acid, and monohydric alcohols such as cyclohexanol and benzyl alcohol can also be used as needed.

It is preferable that the amorphous polyester resin has a monomer unit represented by the following formula (2) (for example, an alkenyl succinic acid unit).

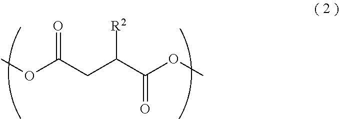

In formula (2), R² represents an alkyl group or alkenyl group having 8 to 16 carbon atoms, and more preferably a dodecenyl group.

By having the monomer unit represented by formula (2), the amorphous polyester resin facilitates the formation of interactions with a crystalline vinyl resin having a long-chain alkyl group, and the amorphous resin also becomes easier to melt. Therefore, even under conditions where fixing is difficult, such as high process speeds, low-temperature fixability tends to be better.

Therefore, among the above-described dibasic acids that can be used in the amorphous polyester resin described above, it is preferable to use dodecenylsuccinic acid to produce the amorphous polyester resin.

The content ratio of the monomer unit represented by formula (2) in the amorphous polyester resin is preferably 3% by mass to 30% by mass, and more preferably 5% by mass to 20% by mass. In molar ratio, it is preferably 0.3 mol % to 30 mol %, and more preferably 8 mol % to 25 mol %.

A method for producing the amorphous polyester resin is not particularly limited, and for example, transesterification or direct polycondensation can be used alone or in combination.

The content ratio of the amorphous polyester resin in the binder resin is, for example, 0.6% by mass to 18.0% by mass, preferably 1.0% by mass to 15.0% by mass, more preferably 2.0% by mass to 10.0% by mass, and even more preferably 4.0% by mass to 10.0% by mass. The amorphous polyester resin is an amorphous resin in which hydrogen abstraction reaction does not occur. Within these ranges, the purity of the crystalline vinyl resin is improved, and since there is not too much amorphous resin, low-temperature fixability tends to be better even under conditions where fixing is difficult, such as high process speeds.

The storage elastic modulus of the amorphous vinyl resin at 80° C. is preferably 1.0×10⁴ Pa to 1.0×10⁷ Pa. Within this range, the viscosity of the amorphous resin of the toner present on the protrusions of the rough paper does not decrease too much during fixing, and mottling is less likely to occur. The storage elastic modulus of the amorphous vinyl resin at 80° C. is more preferably 1.0×10⁴ Pa to 1.0×10⁷ Pa, and even more preferably 1.5×10⁴ Pa to 8.5×10⁶ Pa.

It is preferable that the storage elastic modulus of the amorphous vinyl resin at 80° C. is 1.0 times or more the storage elastic modulus of the crystalline vinyl resin. Within this range, the viscosity of the amorphous vinyl resin and the crystalline vinyl resin tends to be good during fixing, so that low-temperature fixability tends to be good even under conditions where the toner laid-on level on rough paper is large in a low-temperature environment, and mottling is less likely to occur when printing on rough paper.

The storage elastic modulus of the amorphous vinyl resin at 80° C. is preferably 1.0 to 800.0 times, more preferably 1.5 to 500.0 times, and even more preferably 1.8 to 480.0 times the storage elastic modulus of the crystalline vinyl resin.

The toner particle may contain a core having a crystalline vinyl resin and an amorphous vinyl resin, and a shell covering the core, provided that the proportions of the crystalline phase and amorphous phase in regions A and B are within the desired ranges described above. The resin forming the shell is preferably an amorphous polyester resin. The toner particle preferably has a shell of amorphous polyester resin.

The shell does not necessarily have to cover the entire core, and there may be parts where the core is exposed. Having a shell of amorphous polyester resin makes heat-resistant storage stability easier to improve.

When a cross-section of the toner is observed by using a scanning transmission electron microscope, it is preferable that the toner particle has a shell of the amorphous polyester resin. It is also preferable that the toner particle has a domain-matrix structure composed of domains of the amorphous phase and a matrix of the crystalline phase. Furthermore, it is preferable that the toner particle has one or more of these domains having an area of 10.0% by area or more with respect to the total area of the cross-section of the toner particle.

With this structure of the toner particle, low-temperature fixability tends to be better even under conditions where the toner laid-on level on rough paper is large in a low-temperature environment, mottling is less likely to occur when printing on rough paper, and heat-resistant storage stability is more likely to improve.

The toner may contain wax. The wax is preferably at least one selected from the group consisting of hydrocarbon waxes and ester waxes. By using hydrocarbon waxes and/or ester waxes, it becomes easier to ensure effective release properties.

There are no particular limitations on the hydrocarbon wax, and examples include the following.

Aliphatic hydrocarbon waxes: low molecular weight polyethylene, low molecular weight polypropylene, low molecular weight olefin copolymers, Fischer-Tropsch wax, or these waxes that have been oxidized or acid-added.

The ester wax only needs to have at least one ester bond in one molecule, and either natural ester wax or synthetic ester wax may be used.

There are no particular limitations on the ester wax, and examples include the following:
esters of monohydric alcohols and monocarboxylic acids such as behenyl behenate, stearyl stearate, and palmityl palmitate;
esters of dicarboxylic acids and monoalcohols such as dibehenyl sebacate;
esters of dihydric alcohols and monocarboxylic acids such as ethylene glycol distearate and hexanediol dibehenate;
esters of trihydric alcohols and monocarboxylic acids such as glycerol tribehenate;
   esters of tetrahydric alcohols and monocarboxylic acids such as pentaerythritol tetrastearate and pentaerythritol tetrapalmitate;
   esters of hexahydric alcohols and monocarboxylic acids such as dipentaerythritol hexastearate, dipentaerythritol hexapalmitate, and dipentaerythritol hexabehenate;
esters of polyfunctional alcohols and monocarboxylic acids such as polyglycerol behenate; and natural ester waxes such as carnauba wax and rice wax.

Among these, it is preferable that the wax contains an ester wax that is an ester of a tetrahydric to octahydric alcohol and an aliphatic monocarboxylic acid, or a wax that is an ester of a tetrahydric to octahydric carboxylic acid and an aliphatic monoalcohol. Including these waxes improves release properties during low-temperature fixing by reducing compatibility with the crystalline vinyl resin during fixing, making it easier to enhance low-temperature fixability.

Furthermore, esters of tetrahydric alcohols and monocarboxylic acids, such as pentaerythritol tetrastearate, pentaerythritol tetrapalmitate, and pentaerythritol tetrabehenate; esters of hexahydric alcohols and monocarboxylic acids, such as dipentaerythritol hexastearate, dipentaerythritol hexapalmitate, and dipentaerythritol hexabehenate; and esters of octahydric alcohols and monocarboxylic acids, such as tripentaerythritol octastearate, tripentaerythritol octapalmitate, and tripentaerythritol octabehenate, are more preferable.

The content of the wax in the toner particle is preferably 1.0% by mass to 30.0% by mass, more preferably 2.0% by mass to 25.0% by mass, even more preferably 2.0% by mass to 12.0% by mass, and still more preferably 3.0% by mass to 10.0% by mass. Having the content of the wax within these ranges makes it easier to ensure release properties during fixing.

The melting point of the wax is preferably from 60° C. to 120° C. Having the wax melting point within this range allows the wax to melt during fixing and easily permeate to the toner particle surface, making the wax more effective. More preferably, the melting point is from 70° C. to 100° C.

The toner may contain a colorant. Examples of colorants include known organic pigments, organic dyes, inorganic pigments, carbon black as a black colorant, and magnetic particles. Other colorants conventionally used in toners may also be used.

Examples of yellow colorants include the following: condensed azo compounds, isoindolinone compounds, anthraquinone compounds, azo metal complexes, methine compounds, and arylamide compounds. Specifically, C. I. Pigment Yellow 12, 13, 14, 15, 17, 62, 74, 83, 93, 94, 95, 109, 110, 111, 128, 129, 147, 155, 168, and 180 are preferably used.

Examples of magenta colorants include the following: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C. I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254 are preferably used.

Examples of cyan colorants include the following: copper phthalocyanine compounds and derivatives thereof, anthraquinone compounds, and basic dye lake compounds. Specifically, C. I. Pigment Blue 1, 7, 15, 15:1, 15:2, 15:3, 15:4, 60, 62, and 66 are preferably used.

The colorant is selected based on hue angle, saturation, lightness, lightfastness, OHP transparency, and dispersibility in the toner.

The content of the colorant is preferably 1.0 parts by mass to 20.0 parts by mass, and more preferably 2.0 parts by mass to 10.0 parts by mass, per 100.0 parts by mass of the binder resin. When magnetic particles are used as the colorant, the content thereof is preferably 40.0 parts by mass to 150.0 parts by mass per 100.0 parts by mass of the binder resin.

A charge control agent may be included in the toner particle as needed. Alternatively, the charge control agent may be externally added to the toner particle. By incorporating a charge control agent, the charging characteristics can be stabilized, and the optimal triboelectric charge quantity can be controlled according to the development system.

Known charge control agents can be used, and those that have a fast charging speed and can stably maintain a constant charge quantity are particularly preferred.

Examples of charge control agents that control the toner to be negatively charged include the following.

Organometallic compounds and chelate compounds are effective, examples thereof including monoazo metal compounds, acetylacetone metal compounds, and metal compounds based on aromatic oxycarboxylic acids, aromatic dicarboxylic acids, oxycarboxylic acids and dicarboxylic acids.

Examples of charge control agents that control the toner to be positively charged include the following.

Nigrosine, quaternary ammonium salts, metal salts of higher fatty acids, diorganotin borates, guanidine compounds, and imidazole compounds.

The content of the charge control agent is preferably from 0.01 parts by mass to 20.0 parts by mass, and more preferably from 0.5 parts by mass to 10.0 parts by mass, based on 100.0 parts by mass of toner particles.

The toner particles may be used as toner as is, or external additives may be admixed to be attached, as needed, to toner particle surface to form a toner.

Examples of external additives include inorganic fine particles selected from the group consisting of silica fine particles, alumina fine particles, and titania fine particles, or composite oxides thereof. Examples of composite oxides include silica aluminum fine particles and strontium titanate fine particles.

The content of the external additive is preferably from 0.01 parts by mass to 8.0 parts by mass, and more preferably from 0.1 parts by mass to 4.0 parts by mass, based on 100 parts by mass of toner particles.

The toner particles may be manufactured by any known method, such as suspension polymerization, emulsion aggregation, dissolution suspension, or pulverization, as long as the ranges of the features of the present case are satisfied, but it is preferable that the toner particles are manufactured by suspension polymerization.

The toner particles are preferably suspension polymerized toner particles. The suspension polymerization method will be described in detail.

For example, a pre-synthesized crystalline vinyl resin is added to a mixture of polymerizable monomers capable of forming an amorphous resin (e.g., an amorphous vinyl resin). If necessary, other materials such as an amorphous polyester resin, a colorant, a wax, and a charge control agent are added, and the components are uniformly dissolved or dispersed to prepare a polymerizable monomer composition.

Then, the polymerizable monomer composition is dispersed in an aqueous medium using a stirrer or the like to prepare suspended particles of the polymerizable monomer composition. Then, the polymerizable monomers contained in the particles are polymerized using an initiator or the like to obtain toner particles.

During this polymerization reaction, by utilizing a hydrogen abstraction reaction, a certain amount of each polymerizable monomer reacts with the pre-polymerized crystalline vinyl resin, making it easier to control the crystalline vinyl resin to the desired physical properties.

After the polymerization is complete, the toner particles are filtered, washed, and dried by a known method, and if necessary, external additives are added to obtain the toner.

As the polymerization initiator, a known polymerization initiator can be used. Examples include azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyoctoate, t-butyl peroxyneodecanoate, methyl ethyl ketone peroxide, diisopropyl peroxydicarbonate, cumene hydroperoxide, 2,4-dichlorobenzoyl peroxide, and lauroyl peroxide.

Peroxide polymerization initiators are preferably used as polymerization initiators that readily undergo hydrogen abstraction reactions. Among these, initiators such as t-butyl peroxy-2-ethylhexanoate, t-butyl peroxypivalate, t-butyl peroxyisobutyrate, t-butyl peroxyoctoate, and t-butyl peroxyneodecanoate are more preferably used.

The polymerization reaction temperature is preferably from 15° C. to 25° C. higher than the 10-hour half-life temperature of the initiator. Within this range, a moderate hydrogen abstraction reaction is likely to occur, making it easier to control the crystalline vinyl resin to the desired physical properties.

Furthermore, known chain transfer agents and polymerization inhibitors may be used.

The aqueous medium may contain an inorganic or organic dispersion stabilizer. As the dispersion stabilizer, known dispersion stabilizers can be used.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Meanwhile, examples of organic dispersion stabilizers include polyvinyl alcohol, gelatin, methylcellulose, methylhydroxypropylcellulose, ethylcellulose, sodium carboxymethylcellulose, polyacrylic acid and salts thereof, and starch.

When using an inorganic compound as a dispersion stabilizer, a commercially available product may be used as is, but in order to obtain finer particles, the inorganic compound may be produced and used in the aqueous medium.

For example, in the case of calcium phosphate such as hydroxyapatite or tricalcium phosphate, an aqueous solution of a phosphate salt and an aqueous solution of a calcium salt may be mixed under high stirring.

The aqueous medium may contain a surfactant. As the surfactant, known surfactants can be used. Examples include anionic surfactants such as sodium dodecylbenzenesulfonate and sodium oleate; cationic surfactants; amphoteric surfactants; and nonionic surfactants.

The calculation and measurement methods for various physical properties of toner and toner materials are described below.

### Method for Acquiring Cross-Sectional Image of Toner Particle by Using Scanning Transmission Electron Microscope (STEM)

The presence state of crystalline phase and amorphous phase in a cross-section of the toner is confirmed by observing the cross-section of the toner by using a scanning transmission electron microscope. The cross-sectional observation of the toner is performed after ruthenium staining. That is, the cross-sectional image of the toner particle according to the present disclosure is a cross-sectional image of ruthenium-stained toner particle.

The procedure for observing the cross-section of the toner is described hereinbelow.

The toner is embedded in a visible light-curable resin (D-800, manufactured by Nissin EM Co., Ltd.) so that the toner is dispersed as much as possible, followed by cutting to a thin section having a thickness of 100 nm using an ultrasonic ultramicrotome (UC7, manufactured by Leica).

The obtained thin section sample is stained for 15 min in a 500 Pa RuO₄ gas atmosphere using a vacuum staining device (VSC4R1H, manufactured by Philgen Co., Ltd.), and a STEM image is acquired using a scanning transmission electron microscope (JEM2800, manufactured by JEOL, Ltd.). Under the above staining conditions, a difference in the degree of staining occurs between the crystalline resin and the amorphous resin, so the presence state of the crystalline phase and amorphous phase can be confirmed by the difference in contrast. As observation conditions, the acceleration voltage was set to 200 kV, the STEM probe size to 1 nm, the image size to 1024×1024 pixels, and the magnification to 30,000, and a bright-field (STEM-BF) image was acquired.

In this process, when selecting toner particles for obtaining cross-sectional images, the number-average particle diameter of the toner is measured using the measurement method described hereinbelow. Then, ten toner particles having a major axis length that is 0.8 to 1.1 times the number-average particle diameter are selected. Furthermore, images are acquired in such a way that no more than two toner particles are present within the field of view of a single image.

Method for Measuring Proportion of Area of Amorphous Phase in Entire Cross-Section of Toner Particle, Proportion of Area of Crystalline Phase in Region A, and Value of Ratio of Proportion of Area of Amorphous Phase in Region B to Proportion of Area of Amorphous Phase in Region A

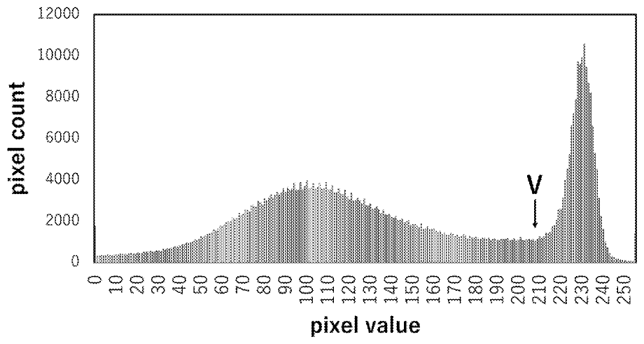

The above proportions of areas are calculated by analyzing the STEM image of the toner particle cross-section obtained by the above method using image processing software ImageJ (developed by Wayne Rasband). A luminance histogram is used for the calculation. The luminance histogram is obtained by measuring a 256-level luminance spectrum from the image obtained from the image analysis of the toner particle cross-section. FIG. 1 shows an example of a 256-level luminance histogram obtained from the cross-sectional image of toner 1. The specific procedure is shown below.

First, the bright-field image to be analyzed is converted to 8-bit from Type in the Image menu.

Next, the image scale is set. An image scale bar is used to set the scale using Set Scale in the Analyze menu. From Filters in the Process menu, the Median diameter is set to 2.0 pixels to reduce image noise.

Next, the range to be analyzed is designated as an area inside the contour of the toner particle. Here, the boundary line of the contour of the toner particle is defined by the interface between the visible light-curable resin and the toner particle cross-section. The area outside the range to be analyzed is erased using Clear Outside in the Edit menu.

The area of the entire cross-section is calculated using Measure in the Analyze menu.

Next, the proportion of the area of the amorphous phase in the entire cross-section is calculated. Where Histogram is selected from the Analyze menu, a luminance histogram with two peaks, one originating from the crystalline phase and the other from the amorphous phase, is displayed. The List is displayed and the pixel value V at the position between the two peaks where the pixel count is lowest is identified. An example of value V is shown in FIG. 1.

In the present disclosure, the crystalline phase and amorphous phase are defined as follows. A STEM image of the toner particle cross-section is analyzed using image processing software to obtain a 256-level luminance histogram. In the obtained luminance histogram, the pixel value at the position between the peak of the crystalline resin and the peak of the amorphous resin, where the pixel count is lowest, is defined as value V.

In the toner particle cross-section, the portion with pixel values corresponding to a luminance from value V to 255 is the “amorphous phase mainly composed of the amorphous resin”.

Also, in the toner particle cross-section, the portion with pixel values corresponding to a luminance 0 or more and less than value V is the “crystalline phase mainly composed of the crystalline resin”.

By selecting Threshold from Adjust in the Image menu, setting the upper bar position to the value V confirmed above and the lower bar position to 255 (maximum), and selecting Apply, only the amorphous phase portion is selected. By checking Summarize in Analyze Particles in the Analyze menu, the total area of the amorphous phase is calculated. The proportion of the amorphous phase area in the entire cross-section of the toner particle is calculated by dividing the total area of the amorphous phase by the area of the entire cross-section.

Next, the total area of region A and the total area of region B are calculated. ROI Manager is opened from Tools in the Analyze menu, and with the region inside the contour of the toner particle selected, Add is selected to add the region inside the contour of the toner particle. Furthermore, with the region inside the contour of the toner particle selected, Enlarge is selected from Selection in the Edit menu and −500 nm is input to select a region where the new contour is 500 nm inside the contour of the toner particle. Since this region is region B, the region outside this region is erased using Clear Outside in the Edit menu.

The total area of region B is calculated using Measure in the Analyze menu. By subtracting the total area of region B from the area of the entire cross-section, the total area of the annular region A with a width of 500 nm, which is surrounded by the contour of the toner particle and the contour of region B, is calculated.

Next, the area of the crystalline phase and the amorphous phase in regions A and B are calculated. By selecting region B in the ROI Manager, selecting Threshold from Adjust in the Image menu, setting the upper bar position to the value V confirmed above and the lower bar position to 255, and selecting Apply, only the amorphous phase portion of region B is selected. By checking Summarize in Analyze Particles in the Analyze menu, the of the amorphous phase in region B is calculated.

The area of the crystalline phase in region B is calculated by subtracting the area of the amorphous phase in region B from the total area of region B. The area of the amorphous phase in region A is calculated by subtracting the area of the amorphous phase in region B from the total area of the amorphous phase in the entire cross-section. The area of the crystalline phase in the entire cross-section is calculated by subtracting the area of the amorphous phase in the entire cross-section from the total area of the cross-section. The area of the crystalline phase in region A is calculated by subtracting the area of the crystalline phase in region B from the area of the crystalline phase in the entire cross-section.

Next, the proportion of the area of the crystalline phase in region A and the value of the ratio of the proportion of the area of the amorphous phase in region B to the proportion of the area of the crystalline phase in region A are calculated. The proportion of the area of the crystalline phase in region A is calculated by dividing the area of the crystalline phase in region A by the total area of region A. The proportion of the area of the amorphous phase in region A is calculated by dividing the area of the amorphous phase in region A by the total area of region A. The proportion of the area of the amorphous phase in region B is calculated by dividing the area of the amorphous phase in region B by the total area of region B. The value of the ratio of the proportion of the area of the amorphous phase in region B to the proportion of the area of the crystalline phase in region A is calculated by dividing the proportion of the area of the amorphous phase in region B by the proportion of the area of the amorphous phase in region A.

Similar image analysis is performed on ten STEM images of each toner, and the above area proportion values and ratio values are calculated. The arithmetic mean of the ten obtained values is used.

### Principle of Ruthenium Staining

When ruthenium staining is performed on the cross-section of toner particle, the crystalline resin component is stained more strongly with ruthenium than the amorphous resin component, resulting in clearer contrast and facilitating the observation of the toner particle cross-section. This is because RuO₄ has strong oxidizing power and oxidizes the long-chain alkyl and alkylene groups that enhance crystallinity, resulting in the crystalline resin component being stained more strongly than the amorphous resin component.

Furthermore, the higher the crystallinity of the resin component, the greater the amount of ruthenium atoms present, and the more ruthenium atoms present, the less the electron beam is transmitted. Therefore, the more crystalline resin component appears more strongly stained in the electron microscope image. Conversely, the amorphous resin component appears weakly stained or unstained. From this, it can be determined that the strongly stained portion contains a crystalline resin, and the weakly stained or unstained portion contains an amorphous resin.

### Confirmation of Shell Layer of Amorphous Polyester Resin

To confirm whether the toner particle has a shell layer of an amorphous polyester resin, TEM-EDX observation (energy-dispersive X-ray analysis using a transmission electron microscope) is used. First, the crystalline vinyl resin, amorphous vinyl resin, and amorphous polyester resin separated by the procedure described hereinbelow are each cut into thin sections having a thickness of 100 nm using an ultrasonic ultramicrotome (UC7, manufactured by Leica) in the same manner as described above.

STEM-EDX observation is implemented on the obtained thin section samples using the STEM function of TEM-EDX (TEM: JEOL, Ltd., JEM2800 (200 keV), EDX detector: JEOL, Ltd., Dry SD 100GV, EDX system: Thermo Fisher Scientific, NORAN SYSTEM7) without performing ruthenium staining.

The STEM probe size is adjusted to 1.0 nm, the storage rate is adjusted to 10,000 cps, and EDX spectra are acquired by selecting the region corresponding to the separated resin. The EDX spectra obtained for each resin are compared to identify elements that are specifically and strongly detected in the amorphous polyester resin (e.g., oxygen).

Next, thin section samples of the toner particles are prepared in the same manner as described above, and STEM images are obtained without performing ruthenium staining. STEM-EDX observation is performed on the obtained cross-sectional images using the STEM function of TEM-EDX. The STEM probe size is adjusted to 1.0 nm, the observation magnification to 30,000, the EDX image size to 256×256 pixels, and the storage rate to 10,000 cps. Mapping images are obtained by integrating 100 frames. Where the intensity of the element specifically detected in the amorphous polyester resin is observed to be strong near the surface of the toner particle, it is determined that the toner particle has a shell layer of the amorphous polyester resin.

Confirmation of Domain Matrix Structure and Domains Having Area of 10.0% by Area or More with Respect to Total Area of Cross-Section of Toner Particle

To confirm that the toner particle has a domain-matrix structure composed of domains of the amorphous phase and a matrix of the crystalline phase, and that the toner particle has one or more of the domains having an area of 10.0% by area or more with respect to the total area of the cross-section of the toner particle, a STEM image obtained after ruthenium staining of the thin section sample prepared as described above is used.

After identifying the domains confirmed by the observed image, the area of the domains is calculated using image processing software Image J (developed by Wayne Rasband). Next, by dividing the area of the domain by the total area of the cross-section, it is confirmed that there is one or more domains with an area of 10.0% by area or more with respect to the total area of the cross-section of the toner particle.

Ten toner particles are observed, and where the abovementioned domain is observed in nine or more toner particles, it is determined that the toner particle in the toner under observation “has one or more of the domains having an area of 10.0% by area or more with respect to the total area of the cross-section”.

### Method for Measuring Number-Average Particle Diameter

The number-average particle diameter of the toner is calculated as follows. As a measuring device, a particle counting and analysis device “CDA-1000X” (manufactured by Sysmex Corporation) using the pore electrical resistance method and equipped with a 100 μm aperture tube is used. The setting of measurement conditions and the analysis of measurement data are performed using the dedicated software “CDA-1000X (Sysmex Corporation)” provided with the device.

For the electrolytic aqueous solution used for measurement, for example, “Cellpack” (manufactured by Sysmex Corporation) can be used.

Before measurement and analysis, the dedicated software is configured as follows.

On the “Measurement Conditions Setting” screen of the dedicated software, the total count is set to 50,000, the number of repeated measurements to 1, and the measurement mode to total count (unlimited).

The specific measurement method is as follows:
(1) A total of 150 ml of the electrolytic aqueous solution is placed in a dedicated glass round-bottom beaker, the beaker is set on the sample stage, and stirring is performed with a stirring propeller at 500 rpm. Then, “Blank Check Measurement” in the dedicated software is clicked to start the measurement, and it is confirmed that the count is less than 500. If the count is 500 or more, the beaker and aperture are repeatedly cleaned.
(2) A total of 30 ml of the electrolytic aqueous solution is placed in a 100 ml glass flat-bottom beaker. To this, 0.3 ml of a diluted solution of “Contaminon N” (a 10% by mass aqueous solution of neutral detergent for precision instrument cleaning, which has a pH of 7 and consists of a nonionic surfactant, an anionic surfactant, and an organic builder, manufactured by Wako Pure Chemical Industries, Ltd.), diluted three times by mass with ion-exchanged water, is added as a dispersing agent.
(3) An ultrasonic disperser “Ultrasonic Dispersion System Tetra 150” (manufactured by Nikko Bios Co., Ltd.) with an electrical output of 120 W that incorporated two oscillators with an oscillation frequency of 50 kHz that were shifted in phase 180 degrees with respect to each other is prepared. A total of 3.3 L of ion-exchanged water is placed in the water tank of the ultrasonic disperser, and 2 ml of Contaminon N is added to this water tank.
(4) The beaker from (2) is set in the beaker fixing hole of the ultrasonic disperser, and the ultrasonic disperser is activated. Then, the height position of the beaker is adjusted so that the resonance state of the liquid surface of the electrolytic aqueous solution in the beaker is maximized.
(5) With the electrolytic aqueous solution in the beaker from (4) irradiated with ultrasonic waves, 10 mg of toner is added little by little and dispersed. Then, the ultrasonic dispersion treatment is continued for another 60 sec. During ultrasonic dispersion, the water temperature in the water bath is adjusted, as appropriate, to be from 10° C. to 40° C.
(6) Using a pipette, the electrolytic aqueous solution from (5) in which the toner has been dispersed is dropped into the round-bottom beaker from (1) placed in a sample stand, and the measurement concentration is adjusted to 6%. Then, measurements are performed until the number of measured particles reaches 50,000.
(7) The measurement data are analyzed using the dedicated software provided with the device, and the number-average particle diameter is calculated.
   Separation of Crystalline Vinyl Resin, Amorphous Vinyl Resin, Amorphous Polyester Resin, and Wax from Toner, and Measurement of Content Ratio Thereof

A total of 1.5 g of toner is weighed and placed in a cylindrical filter paper (product name: No. 86R, size 28×100 mm, manufactured by Advantec Toyo Co., Ltd.) and set in a Soxhlet extractor. In this case, 200 mL of chloroform is used as a solvent for 18 h of extraction, and the extraction is performed at a reflux rate such that the solvent extraction cycle is once every 5 min. From the extracted chloroform-soluble components, the chloroform is sufficiently distilled off using an evaporator to separate the mixture of resin components such as binder resin and wax, which are chloroform-soluble components, from the toner.

For the separation of the binder resin and wax, components with a molecular weight of 2000 or less are separated as wax by recycling HPLC. The measurement method is described hereinbelow. First, the mixture of resin components and wax is dissolved in chloroform using the method described above. The resulting solution is filtered through a solvent-resistant membrane filter with a pore size of 0.2 μm, “MyShori Disc” (manufactured by Tosoh Corporation), to obtain a sample solution. The sample solution is adjusted so that the concentration of the chloroform-soluble components is 1.0% by mass. This sample solution is then measured under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 ml/min
Oven temperature: 40.0° C.
Sample injection volume: 1.0 ml

For calculating the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, and A-500” manufactured by Tosoh Corporation) is used.

From the molecular weight curve thus obtained, components with a molecular weight of 2000 or less can be repeatedly fractionated to separate the binder resin and wax.

The separation of crystalline vinyl resin, amorphous vinyl resin, and amorphous polyester resin from the binder resin can be performed by gradient polymer LC using the following method.

The binder resin separated by the method described above is used as a sample, and the sample concentration is adjusted to 1.0% by mass using chloroform. The resulting solution is filtered through a 0.45 μm PTFE filter and then subjected to measurement. The gradient polymer LC measurement conditions are shown below.
Equipment: ULTIMATE3000 (Thermo Fisher Scientific)
Mobile phase: A: chloroform (HPLC), B: acetonitrile (HPLC)
Gradient: 2 min (A/B=0/100)→25 min (A/B=100/0)
(The gradient of the mobile phase change is set to be linear.)
Flow rate: 1.0 mL/min
Injection: 1.0% by mass×20 μL
Column: Tosoh TSKgel ODS (4.6 mmφ×150 mm×5 μm)
Column temperature: 40° C.
Detector: Corona Charged Aerosol Detector (Corona-CAD) (manufactured by Thermo Fisher Scientific)

In the time—signal intensity (μA) graph obtained from the measurement, the binder resin can be separated into three peaks depending on its polarity. Then, the above measurement is repeated, and by fractionating at the time corresponding to the valleys of each peak, the three types of resins can be separated. By performing compositional analysis on the separated resins using the method described below, the crystalline vinyl resin, amorphous vinyl resin, and amorphous polyester resin are identified. By measuring the mass of the separated resins, the content ratios of crystalline vinyl resin, amorphous vinyl resin, and amorphous polyester resin in the binder resin are calculated.

Furthermore, the content ratio of amorphous vinyl resin in the amorphous resin can also be calculated. The following analysis can be performed using the crystalline vinyl resin, amorphous vinyl resin, and amorphous polyester resin separated by these procedures.

### Composition Analysis Method for Monomer Unit (a) of Crystalline Vinyl Resin, Amorphous Vinyl Resin, and Monomer Unit of Formula (2) of Amorphous Polyester Resin

Composition analysis of the monomer unit (a) of crystalline vinyl resin, amorphous vinyl resin, and the monomer unit of formula (2) of amorphous polyester resin is performed by ¹H-NMR and ¹³C-NMR under the following conditions. As an example, analysis of crystalline vinyl resin will be described. The measurement sample can be the crystalline vinyl resin separated by the method described above.
Measurement device: FT NMR spectrometer JNM-EX400 (manufactured by JEOL, Ltd.)
Measurement frequency: 400 MHz
Pulse conditions: 5.0 μs
Frequency range: 10500 Hz
Number of accumulations: 64 times
Measurement temperature: 30° C.
Sample: 50 mg of the measurement sample is placed in a sample tube having an inner diameter of 5 mm, deuterated chloroform (CDCl₃) is added as a solvent, and dissolution is performed in a constant temperature bath at 40° C. to prepare the sample. The obtained ¹H-NMR chart is analyzed to identify the structure of each unit. Here, as an example, the measurement of the content ratio of monomer unit (a) and the number of carbon atoms in the alkyl group in the crystalline vinyl resin is described.

In the obtained ¹H-NMR chart, from among the peaks attributed to the constituent elements of monomer unit (a), a peak is selected that is independent of the peaks attributed to the constituent elements of other monomer units, and the integral value S1 of this peak is calculated. The integral values are similarly calculated for the other units contained in the crystalline vinyl resin.

For example, if the monomer units constituting the crystalline vinyl resin are monomer unit (a) and one other monomer unit, the content ratio of monomer unit (a) is determined in the following manner by using the above integral value S1 and an integral value S2 of the peak of the other monomer unit. Here, n1 and n2 represent the number of hydrogen atoms in the structural components to which the peaks observed at each respective region are attributed.

$$Content ratio of monomer unit ( a ) ( mol \% ) = \{ ( S 1 / n 1 ) / ( ( S 1 / n 1 ) + ( S 2 / n 2 ) ) \} \times 100$$

The content ratio of monomer unit (a) can be calculated similarly (using S3 . . . . Sx, n3 . . . nx) when there are two or more other monomer units.

The number of carbon atoms in the alkyl group can be calculated from the integral ratio of the proton peaks in the 1H-NMR chart.

Where a polymerizable monomer is used that does not contain hydrogen atoms in constituent elements other than the vinyl group, the measurement is performed using ¹³C-NMR with ¹³C as the measured nucleus in a single-pulse mode, and the calculation is performed in the same manner as with ¹H-NMR.

The ratio of each monomer unit (mol %) calculated by the above method is multiplied by the molecular weight of each monomer unit to convert the content ratio of each monomer unit to percents by mass. In this manner, the content ratio (ratio J) of monomer unit (a) in the crystalline vinyl resin, based on the mass of the crystalline vinyl resin, is calculated. For example, the calculation can be performed by the following formula.

[Content ratio of monomer unit (a) based on the mass of crystalline vinyl resin: Ratio J (unit: mass %) (Molecular weight of monomer unit (a): M1, molecular weight of other monomer unit: M2)]

$$Ratio J = \{ ( S 1 / n 1 ) \times M 1 / ( ( S 1 / n 1 ) \times M 1 + ( S 2 / n 2 ) \times M2 ) \} \times 100 \qquad ( 7 )$$

The same method can be used for measurement with respect to the amorphous vinyl resin and amorphous polyester resin.

Method for Measuring Melting Point Peak of Crystalline Vinyl Resin in Differential Scanning calorimetry (DSC) Measurement of Toner

The melting point peak of the crystalline vinyl resin is measured using DSC Q2000 (manufactured by TA Instruments, Inc.) under the following conditions:
Temperature rise rate: 10° C./min
Measurement start temperature: 20° C.
Measurement end temperature: 180° C.

The temperature correction of the device detection unit uses the melting points of indium and zinc, and the heat quantity correction uses the heat of fusion of indium.

Specifically, 5 mg of toner is accurately weighed, placed in an aluminum pan, and differential scanning calorimetry is performed. An empty silver pan is used as a reference. In the temperature rise process, the temperature is raised to 180° C. at a rate of 10° C./min. Then, the peak temperature is calculated from each peak.

If the toner contains wax, an endothermic peak derived from the wax may also be observed. In that case, by separately measuring the DSC of the separated wax using the above method, the endothermic peak of the wax can be identified, and the melting point peak derived from the crystalline vinyl resin can be specified.

### Measurement of Storage Elastic Modulus of Crystalline Vinyl Resin or Amorphous Vinyl Resin at 80° C.

The storage elastic modulus was measured using an MCR302 (manufactured by Anton Paar GmbH). A method for measuring the storage elastic modulus of crystalline vinyl resin at 80° C. is described below.

A total of 120 mg of crystalline vinyl resin or amorphous vinyl resin is weighed and molded using a tablet molding machine at 20 kN for 1 min to obtain a disc-shaped sample with a diameter of 8 mm.

The sample obtained is set in the measuring jig under the following conditions.
Measuring jig name: Measuring plate PP08/SD: 8 mm sandblasted
Setting conditions: 80° C., 0.1 N

Next, viscoelastic measurements were performed under the following conditions:
Frequency: 1 Hz
Normal force: 100 mN
Applied strain: changed from 0.5% to 7.0% at a rate of 0.22%/min

The measurement is performed while increasing the temperature from 60° C. to 100° C. at a rate of 2° C./min. The sampling pitch during this measurement is 1 point/0.5 min.

In the above measurement, the calculated value of the storage elastic modulus (Pa) at 80° C. is defined as the storage elastic modulus of the crystalline vinyl resin or amorphous vinyl resin at 80° C.

### Method for Measuring Molecular Weight of Crystalline Vinyl Resin

The molecular weight (weight-average molecular weight Mw) of the THF-soluble component of the crystalline vinyl resin is measured by gel permeation chromatography (GPC) in the following manner.

First, the crystalline vinyl resin is dissolved in tetrahydrofuran (THF) over 24 h at room temperature. Then, the obtained solution is filtered with a solvent-resistant membrane filter “MyShori Disc” (manufactured by Tosoh Corporation) with a pore size of 0.2 μm to obtain a sample solution. The sample solution is adjusted so that the concentration of the THF-soluble component is 0.8% by mass. Using this sample solution, measurements are performed under the following conditions.
Apparatus: HLC8120 GPC (Detector: RI) (manufactured by Tosoh Corporation)
Column: seven columns in series: Shodex KF-801, 802, 803, 804, 805, 806, 807 (manufactured by Showa Denko K.K.)
Eluent: tetrahydrofuran (THF)
Flow rate: 1.0 ml/min
Oven temperature: 40.0° C.
Sample injection volume: 0.10 ml

For calculating the molecular weight of the sample, a molecular weight calibration curve prepared using standard polystyrene resins (for example, product names “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation) is used.

### EXAMPLES

The present disclosure will be specifically explained below with reference to examples, but these do not limit the present disclosure in any way. In the following formulations, “parts” are by mass unless otherwise specified.

### Preparation of Crystalline Vinyl Resin Precursor 1

The following materials were added to a reaction container equipped with a reflux condenser, a stirrer, a thermometer, and a nitrogen introduction tube under a nitrogen atmosphere.
Toluene: 100.0 parts
Monomer composition: 100.0 parts
(The monomer composition is a mixture of the following monomers in the following proportions)
   (Behenyl acrylate: 60.0 parts)
   (Styrene: 15.0 parts)
   (Acrylonitrile: 20.0 parts)
   (n-Butyl acrylate: 5.0 parts)
Polymerization initiator: t-butyl peroxypivalate (Perbutyl PV, manufactured by NOF Corporation): 0.5 parts

While stirring inside the reaction container at 200 rpm, the components were heated to 70° C. and a polymerization reaction was carried out for 12 h to obtain a solution in which the polymer of the monomer composition was dissolved in toluene. Next, after cooling the solution to 25° C., the solution was added to 1000.0 parts of methanol while stirring, and the methanol-insoluble components were precipitated. The obtained methanol-insoluble components were filtered off, washed with methanol, and then vacuum-dried at 40° C. for 24 h to obtain crystalline vinyl resin precursor 1. The physical properties of crystalline vinyl resin precursor 1 are shown in Table 1.

### Preparation of Crystalline Vinyl Resin Precursors 2 to 9

Crystalline vinyl resin precursors 2 to 9 were prepared in the same manner as in the preparation of crystalline vinyl resin precursor 1, except that the type and amount added of the monomer composition were changed as shown in Table 1. The physical properties of crystalline resins 2 to 9 are shown in Table 1.

TABLE 1

| Crystalline | Monomer(a) | | | | | | | | | | |
|---|---|---|---|---|---|---|---|---|---|---|---|
| vinyl resin | | Number of | | | | | | | | Polymerization | Molecular |
| precursor | | carbon atoms | | Other monomer1 | | Other monomer2 | | Other monomer3 | | initiator | weight |
| No. | Type | n | Parts | Type | Parts | Type | Parts | Type | Parts | Parts | Mw |
| 1 | Behenyl acrylate | 21 | 60.0 | Styrene | 15.0 | Acrylonitrile | 20.0 | n-Butyl acrylate | 5.0 | 0.5 | 30200 |
| 2 | Behenyl acrylate | 21 | 50.0 | Styrene | 15.0 | Acrylonitrile | 20.0 | n-Butyl acrylate | 5.0 | 0.5 | 30700 |
| | Stearyl acrylate | 17 | 10.0 | | | | | | | | |
| 3 | Behenyl acrylate | 21 | 20.0 | Styrene | 15.0 | Acrylonitrile | 20.0 | n-Butyl acrylate | 5.0 | 0.5 | 31800 |
| | Stearyl acrylate | 17 | 40.0 | | | | | | | | |
| 4 | Behenyl acrylate | 21 | 30.0 | Styrene | 15.0 | Acrylonitrile | 20.0 | n-Butyl acrylate | 5.0 | 0.5 | 29700 |
| | Myristyl acrylate | 29 | 30.0 | | | | | | | | |
| 5 | Myristyl acrylate | 29 | 60.0 | Styrene | 15.0 | Acrylonitrile | 20.0 | n-Butyl acrylate | 5.0 | 0.5 | 31560 |
| 6 | Behenyl acrylate | 21 | 50.0 | Styrene | 25.0 | Acrylonitrile | 20.0 | n-Butyl acrylate | 5.0 | 0.5 | 31800 |
| 7 | Behenyl acrylate | 21 | 70.0 | Styrene | 15.0 | Acrylonitrile | 10.0 | n-Butyl acrylate | 5.0 | 0.5 | 30200 |
| 8 | Behenyl acrylate | 21 | 80.0 | Styrene | 10.0 | Acrylonitrile | 5.0 | n-Butyl acrylate | 5.0 | 0.5 | 31900 |
| 9 | Stearyl acrylate | 17 | 60.0 | Styrene | 15.0 | Acrylonitrile | 20.0 | n-Butyl acrylate | 5.0 | 0.5 | 32600 |

### Preparation of Amorphous Polyester Resin 1

Bisphenol A-propylene oxide 2-mole adduct: 1000 parts by mass
Isophthalic acid: 270 parts by mass
Dodecenylsuccinic acid (unit monomer of formula (2)): 250 parts by mass

The above monomers were charged into a flask equipped with a stirring device, a nitrogen introduction tube, a temperature sensor, and a rectification column, the temperature was raised to 195° C. over 1 h, and uniform stirring in the reaction system was confirmed. A total of 1.2 parts by mass of tin distearate were added to 100 parts by mass of these monomers. Furthermore, the temperature was raised from 195° C. to 240° C. over 5 h while distilling off the generated water, and the dehydration condensation reaction was further carried out at 240° C. for another 2 h.

Next, the temperature was lowered to 190° C., and the reaction was continued at 190° C. for 1 hour to obtain amorphous polyester resin 1. The physical properties of the obtained amorphous polyester resin 1 are shown in Table 2.

### Preparation of Amorphous Polyester Resins 2 to 4

Amorphous polyester resins 2 to 4 were prepared in the same manner as in the preparation of amorphous polyester resin 1, except that the type and amount of acid monomer and alcohol monomer used were changed as shown in Table 2. The physical properties of amorphous polyester resins 2 to 4 are shown in Table 2.

TABLE 2

| | Alcohol | Acid monomer | | | Physical properties of resin | | |
|---|---|---|---|---|---|---|---|
| Amorphous | monomer | | Unit monomer | | | Acid | Molecular |
| polyester | BPA-2PO | IPA | of formula (2) | | Tg | value | weight |
| resin No. | Parts | Parts | Parts | Type of R1 | [° C.] | [mgKOH/g] | [Mw] |
| 1 | 1000 | 250 | 300 | Dodecenyl | 64.2 | 5.7 | 14300 |
| | | | | group | | | |
| 2 | 1000 | 350 | 150 | Dodecenyl | 70.7 | 5.4 | 13700 |
| | | | | group | | | |
| 3 | 1000 | 420 | 50 | Dodecenyl | 71.5 | 5.5 | 13200 |
| | | | | group | | | |
| 4 | 1000 | 450 | 0 | Dodecenyl | 72.3 | 4.9 | 13100 |
| | | | | group | | | |

BPA-2PO: Bisphenol A - propylene oxide 2-mole adduct
IPA: Isophthalic acid

### Example 1

### Production of Toner by Suspension Polymerization Method

### Production of Toner Particles 1

A mixture consisting of:
Styrene: 54.6 parts
n-Butyl acrylate: 15.4 parts
Colorant (Pigment Blue 15:3): 6.5 parts
   was prepared. The mixture was placed in an attritor (manufactured by Nippon Coke & Engineering Co., Ltd.) and dispersed for 2 h at 200 rpm using zirconia beads having a diameter of 5 mm to obtain a raw material dispersion liquid.

Meanwhile, 735.0 parts of ion-exchanged water and 16.0 parts of trisodium phosphate (dodecahydrate) were added to a container equipped with a high-speed stirrer Homomixer (manufactured by Primix Corporation) and a thermometer, and the temperature was raised to 60° C. while stirring at 12,000 rpm. A calcium chloride aqueous solution prepared by dissolving 9.0 parts of calcium chloride (dihydrate) in 65.0 parts of ion-exchanged water was then added, and the mixture was stirred at 12,000 rpm for 30 min while maintaining the temperature at 60° C. 10% hydrochloric acid was then added to adjust the pH to 6.0, thereby obtaining an aqueous medium in which an inorganic dispersion stabilizer containing hydroxyapatite was dispersed in water.

Subsequently, the raw material dispersion liquid was transferred to a container equipped with a stirrer and a thermometer, and the temperature was raised to 60° C. while stirring at 100 rpm.
Crystalline vinyl resin precursor 1:25.0 parts
Amorphous polyester resin 1:5.0 parts
DP18 (dipentaerythritol stearate ester wax, melting point 79° C., manufactured by Nisshin Oillio Co., Ltd.): 9.0 parts

The above materials were added to the container and stirred at 100 rpm for 30 min while maintaining a temperature of 60° C. A total of 8.0 parts of t-butyl peroxypivalate (Perbutyl PV, manufactured by NOF Corporation) was added as a polymerization initiator, and the mixture was stirred for another minute. The resulting mixture was added to an aqueous medium under stirring at 12,000 rpm using the high-speed stirring device. Stirring was continued at 12,000 rpm for 20 min using the high-speed stirring device while maintaining a temperature of 60° C. to obtain a granulation liquid.

The granulation liquid was transferred to a reaction container equipped with a reflux condenser, a stirrer, a thermometer, and a nitrogen introduction tube, and the temperature was raised to 76° C. while stirring at 150 rpm under a nitrogen atmosphere. The polymerization reaction was carried out at 76° C. for 6 h while stirring at 150 rpm to obtain a toner particle dispersion liquid.

The obtained toner particle dispersion liquid was cooled to 45° C. while stirring at 150 rpm, and then heat-treated for 5 h while maintaining the temperature at 45° C. Afterward, while maintaining stirring, dilute hydrochloric acid was added until the pH reached 1.5 to dissolve the dispersion stabilizer. The solid fraction was filtered, thoroughly washed with deionized water, and then vacuum-dried at 30° C. for 24 h to obtain toner particles 1.

### Preparation of Toner 1

A total of 2.0 parts of silica fine particles (hydrophobically treated with hexamethyldisilazane, number-average particle diameter of primary particles: 10 nm, BET specific surface area: 170 m²/g) were added as an external additive to 98.0 parts of toner particles 1 and mixed using a Henschel mixer (manufactured by Nippon Coke & Engineering Co., Ltd.) at 3000 rpm for 15 min to obtain toner 1. The physical properties of the obtained toner 1 are shown in Tables 4-1 to 4-3, and the evaluation results are shown in Table 5.

FIG. 2 shows one of the ten 256-level brightness histograms obtained from the STEM image of the cross-section of the obtained toner particles 1.

TABLE 3

| | | | Resin | | | | | | | | |
|---|---|---|---|---|---|---|---|---|---|---|---|
| | | | Crystalline resin | | | | | | | | |
| | | | Crystalline | | | | | | Amorphous | | |
| | | | vinyl resin | | Polymerizable | | Polymerizable | | polyester | | Polymerization |
| | Toner | Production | precursor | | monomer1 | | monomer2 | | resin | | initiator |
| | No. | method | No. | Parts | Type | Parts | Type | Parts | No. | Parts | Parts |
| Example1 | 1 | Suspension polymerization method | 1 | 25.0 | St | 54.6 | nBA | 15.4 | 1 | 5.0 | 8.0 |
| Example2 | 2 | Suspension polymerization method | 2 | 25.0 | St | 54.6 | nBA | 15.4 | 1 | 5.0 | 8.0 |
| Example3 | 3 | Suspension polymerization method | 3 | 25.0 | St | 54.6 | nBA | 15.4 | 1 | 5.0 | 8.0 |
| Example4 | 4 | Suspension polymerization method | 4 | 25.0 | St | 54.6 | nBA | 15.4 | 1 | 5.0 | 8.0 |
| Example5 | 5 | Suspension polymerization method | 5 | 25.0 | St | 54.6 | nBA | 15.4 | 1 | 5.0 | 8.0 |
| Example6 | 6 | Suspension polymerization method | 1 | 30.0 | St | 50.7 | nBA | 14.3 | 1 | 5.0 | 8.0 |
| Example7 | 7 | Suspension polymerization method | 1 | 35.0 | St | 46.8 | nBA | 13.2 | 1 | 5.0 | 8.0 |
| Example8 | 8 | Suspension polymerization method | 1 | 10.0 | St | 66.3 | nBA | 18.7 | 1 | 5.0 | 8.0 |
| Example9 | 9 | Suspension polymerization method | 1 | 10.0 | St | 67.5 | nBA | 19.0 | 1 | 3.5 | 8.0 |
| Example10 | 10 | Suspension polymerization method | 1 | 10.0 | St | 68.6 | nBA | 19.4 | 1 | 2.0 | 8.0 |
| Example11 | 11 | Suspension polymerization method | 1 | 25.0 | St | 55.8 | nBA | 15.7 | 1 | 3.5 | 8.0 |
| Example12 | 12 | Suspension polymerization method | 1 | 25.0 | St | 56.9 | nBA | 16.1 | 1 | 2.0 | 8.0 |
| Example13 | 13 | Suspension polymerization method | 1 | 25.0 | St | 53.8 | nBA | 15.2 | 1 | 6.0 | 8.0 |
| Example14 | 14 | Suspension polymerization method | 1 | 15.0 | St | 64.7 | nBA | 18.3 | 1 | 2.0 | 8.0 |
| Example15 | 15 | Suspension polymerization method | 1 | 30.0 | St | 48.4 | nBA | 13.6 | 1 | 8.0 | 8.0 |
| Example16 | 16 | Suspension polymerization method | 1 | 35.0 | St | 39.8 | nBA | 11.2 | 1 | 14.0 | 8.0 |
| Example17 | 17 | Suspension polymerization method | 1 | 37.0 | St | 38.2 | nBA | 10.8 | 1 | 14.0 | 8.0 |
| Example18 | 18 | Suspension polymerization method | 1 | 25.0 | St | 47.6 | nBA | 13.4 | 1 | 14.0 | 8.0 |
| Example19 | 19 | Suspension polymerization method | 1 | 25.0 | St | 46.0 | nBA | 13.0 | 1 | 16.0 | 8.0 |
| Example20 | 20 | Suspension polymerization method | 1 | 25.0 | St | 57.9 | nBA | 16.3 | 1 | 0.8 | 8.0 |
| Example21 | 21 | Suspension polymerization method | 6 | 25.0 | St | 54.6 | nBA | 15.4 | 1 | 5.0 | 8.0 |
| Example22 | 22 | Suspension polymerization method | 7 | 25.0 | St | 54.6 | nBA | 15.4 | 1 | 5.0 | 8.0 |
| Example23 | 23 | Suspension polymerization method | 8 | 25.0 | St | 54.6 | nBA | 15.4 | 1 | 5.0 | 8.0 |
| Example24 | 24 | Suspension polymerization method | 1 | 25.0 | St | 54.6 | nBA | 15.4 | 1 | 5.0 | 4.0 |
| Example25 | 25 | Suspension polymerization method | 1 | 25.0 | St | 54.6 | nBA | 15.4 | 1 | 5.0 | 10.0 |
| Example26 | 26 | Suspension polymerization method | 1 | 25.0 | St | 54.6 | nBA | 15.4 | 2 | 5.0 | 8.0 |
| Example27 | 27 | Suspension polymerization method | 1 | 25.0 | St | 54.6 | nBA | 15.4 | 3 | 5.0 | 8.0 |
| Example28 | 28 | Suspension polymerization method | 1 | 25.0 | St | 54.6 | nBA | 15.4 | 4 | 5.0 | 8.0 |
| Comparative | Comparative1 | Suspension polymerization method | 9 | 25.0 | St | 54.6 | nBA | 15.4 | 1 | 5.0 | 8.0 |
| Example1 | | | | | | | | | | | |
| Comparative | Comparative2 | Suspension polymerization method | 1 | 38.0 | St | 44.5 | nBA | 12.5 | 1 | 5.0 | 8.0 |
| Example2 | | | | | | | | | | | |
| Comparative | Comparative3 | Suspension polymerization method | 1 | 10.0 | St | 69.4 | nBA | 19.6 | 1 | 1.0 | 8.0 |
| Example3 | | | | | | | | | | | |
| Comparative | Comparative4 | Suspension polymerization method | 1 | 25.0 | St | 58.0 | nBA | 16.4 | 1 | 0.6 | 8.0 |
| Example4 | | | | | | | | | | | |

In the table, St stands for styrene, and nBA stands for n-butyl acrylate.

TABLE 4-1

| | | | Peak temperature | Proportion of area | | (Proportion of area of |
|---|---|---|---|---|---|---|
| | | Number-average | of melting point | of amorphous phase | Proportion of area | amorphous phase in |
| | | particle diameter | peak derived from | in entire cross-section | of crystalline phase | region B)/(proportion |
| | Toner | of toner | crystalline vinyl resin | of toner particle | in region A | of area of amorphous |
| | No. | (μm) | (° C.) | (% by area) | (% by area) | phase in region A) |
| Example1 | 1 | 6.2 | 61.2 | 31.0 | 90.0 | 4.4 |
| Example2 | 2 | 6.1 | 57.0 | 35.0 | 88.0 | 4.2 |
| Example3 | 3 | 6.0 | 52.1 | 31.0 | 92.0 | 4.5 |
| Example4 | 4 | 6.4 | 66.7 | 29.0 | 91.0 | 4.2 |
| Example5 | 5 | 6.4 | 74.1 | 28.0 | 92.0 | 4.8 |
| Example6 | 6 | 6.1 | 61.3 | 25.0 | 90.0 | 3.3 |
| Example7 | 7 | 6.3 | 61.0 | 16.0 | 92.0 | 2.9 |
| Example8 | 8 | 6.4 | 61.3 | 57.0 | 82.0 | 3.9 |
| Example9 | 9 | 6.3 | 61.0 | 57.0 | 74.0 | 3.0 |
| Example10 | 10 | 6.2 | 61.1 | 59.0 | 66.0 | 2.5 |
| Example11 | 11 | 6.4 | 61.2 | 34.0 | 85.0 | 2.3 |
| Example12 | 12 | 6.4 | 60.8 | 32.0 | 80.0 | 1.7 |
| Example13 | 13 | 6.1 | 61.0 | 33.0 | 93.0 | 6.8 |
| Example14 | 14 | 6.2 | 60.8 | 45.0 | 63.0 | 1.6 |
| Example15 | 15 | 6.1 | 60.9 | 28.0 | 97.0 | 9.9 |
| Example16 | 16 | 6.1 | 61.2 | 21.0 | 84.0 | 1.7 |
| Example17 | 17 | 6.0 | 61.3 | 23.0 | 81.0 | 1.5 |
| Example18 | 18 | 6.1 | 61.3 | 36.0 | 85.0 | 3.5 |
| Example19 | 19 | 6.0 | 61.3 | 36.0 | 82.0 | 3.2 |
| Example20 | 20 | 6.5 | 61.0 | 34.0 | 73.0 | 1.5 |
| Example21 | 21 | 6.4 | 61.3 | 35.0 | 87.0 | 4.2 |
| Example22 | 22 | 6.2 | 61.2 | 29.0 | 91.0 | 4.3 |
| Example23 | 23 | 6.2 | 61.2 | 27.0 | 93.0 | 4.2 |
| Example24 | 24 | 6.2 | 61.3 | 33.0 | 89.0 | 4.3 |
| Example25 | 25 | 6.2 | 61.0 | 26.0 | 93.0 | 4.3 |
| Example26 | 26 | 6.3 | 61.1 | 30.0 | 90.0 | 4.5 |
| Example27 | 27 | 6.3 | 61.1 | 31.0 | 89.0 | 4.3 |
| Example28 | 28 | 6.3 | 61.1 | 30.0 | 89.0 | 4.2 |
| Example29 | 29 | 6.5 | 61.5 | 31.0 | 84.0 | 4.0 |
| Example30 | 30 | 6.4 | 61.5 | 45.0 | 61.0 | 1.5 |
| Comparative | Comparative1 | 6.2 | 47.0 | 33.0 | 90.0 | 4.5 |
| Example1 | | | | | | |
| Comparative | Comparative2 | 6.1 | 61.2 | 14.0 | 93.0 | 2.6 |
| Example2 | | | | | | |
| Comparative | Comparative3 | 6.3 | 61.3 | 56.0 | 57.0 | 1.7 |
| Example3 | | | | | | |
| Comparative | Comparative4 | 6.0 | 61.0 | 32.0 | 73.0 | 1.3 |
| Example4 | | | | | | |
| Comparative | Comparative5 | 6.2 | 65.0 | 54.0 | 45.0 | 1.0 |
| Example5 | | | | | | |
| Comparative | Comparative6 | 6.3 | 62.0 | 0.0 | 100.0 | — |
| Example6 | | | | | | |

TABLE 4-2

| | | Ratio of | Content ratio of | Content ratio of | Content ratio of |
|---|---|---|---|---|---|
| | | amorphous vinyl resin | amorphous vinyl resin | crystalline vinyl resin | amorphous polyester resin |
| | Toner | in amorphous resin | in binder resin | in binder resin | in binder resin |
| | No. | (% by mass) | (% by mass) | (% by mass) | (% by mass) |
| Example1 | 1 | 89.0 | 40.3 | 54.7 | 5.0 |
| Example2 | 2 | 88.3 | 37.7 | 57.3 | 5.0 |
| Example3 | 3 | 88.5 | 38.6 | 56.4 | 5.0 |
| Example4 | 4 | 89.1 | 40.8 | 54.2 | 5.0 |
| Example5 | 5 | 89.4 | 42.1 | 52.9 | 5.0 |
| Example6 | 6 | 87.1 | 33.8 | 61.2 | 5.0 |
| Example7 | 7 | 81.2 | 21.6 | 73.4 | 5.0 |
| Example8 | 8 | 93.7 | 74.9 | 20.1 | 5.0 |
| Example9 | 9 | 95.6 | 76.1 | 20.4 | 3.5 |
| Example10 | 10 | 97.5 | 77.5 | 20.5 | 2.0 |
| Example11 | 11 | 92.5 | 43.2 | 53.3 | 3.5 |
| Example12 | 12 | 95.6 | 43.0 | 55.0 | 2.0 |
| Example13 | 13 | 86.9 | 39.7 | 54.3 | 6.0 |
| Example14 | 14 | 97.0 | 65.7 | 32.3 | 2.0 |
| Example15 | 15 | 79.4 | 30.9 | 61.1 | 8.0 |
| Example16 | 16 | 51.4 | 14.8 | 71.2 | 14.0 |
| Example17 | 17 | 43.8 | 10.9 | 75.1 | 14.0 |
| Example18 | 18 | 70.8 | 33.9 | 52.1 | 14.0 |
| Example19 | 19 | 66.8 | 32.2 | 51.8 | 16.0 |
| Example20 | 20 | 98.2 | 44.4 | 54.8 | 0.8 |
| Example21 | 21 | 89.6 | 43.0 | 52.0 | 5.0 |
| Example22 | 22 | 88.1 | 37.0 | 58.0 | 5.0 |
| Example23 | 23 | 86.5 | 32.0 | 63.0 | 5.0 |
| Example24 | 24 | 89.5 | 42.7 | 52.3 | 5.0 |
| Example25 | 25 | 86.0 | 30.6 | 64.4 | 5.0 |
| Example26 | 26 | 88.9 | 40.0 | 55.0 | 5.0 |
| Example27 | 27 | 88.9 | 40.0 | 55.0 | 5.0 |
| Example28 | 28 | 88.9 | 40.0 | 55.0 | 5.0 |
| Example29 | 29 | 88.9 | 40.0 | 55.0 | 5.0 |
| Example30 | 30 | 90.9 | 50.0 | 45.0 | 5.0 |
| Comparative Example1 | Comparative1 | 88.6 | 39.0 | 56.0 | 5.0 |
| Comparative Example2 | Comparative2 | 79.8 | 19.8 | 75.2 | 5.0 |
| Comparative Example3 | Comparative3 | 98.7 | 78.2 | 20.8 | 1.0 |
| Comparative Example4 | Comparative4 | 98.7 | 44.8 | 54.6 | 0.6 |
| Comparative Example5 | Comparative5 | 100.0 | 59.8 | 40.2 | 0.0 |
| Comparative Example6 | Comparative6 | — | 0.0 | 100.0 | 0.0 |

TABLE 4-3

| | | | | (Storage elastic | | | | |
|---|---|---|---|---|---|---|---|---|
| | | | | modulus of | | | | |
| | | | | amorphous | | | | |
| | | | | vinyl resin | | | | |
| | | Storage elastic | Storage elastic | at 80° C.)/ | Weight- | | Amorphous | Amorphous |
| | | modulus of | modulus of | (Storage elastic | average | | phase | phase domains |
| | | crystalline | amorphous | modulus of | molecular | Shell of | domains | taking 10.0% |
| | | vinyl resin | vinyl resin | crystalline | weight of | amorphous | and | by area or |
| | Toner | at 80° C. | at 80° C. | vinyl resin | crystalline | polyester | crystalline | more of |
| | No. | (Pa) | (Pa) | at 80° C.) | vinyl resin | resin | phase matrix | cross-section |
| Example1 | 1 | 110000 | 1500000 | 13.6 | 156800 | Present | Present | Present |
| Example2 | 2 | 83000 | 1500000 | 18.1 | 147800 | Present | Present | Present |
| Example3 | 3 | 63000 | 1500000 | 23.8 | 152800 | Present | Present | Present |
| Example4 | 4 | 180000 | 1500000 | 8.3 | 163400 | Present | Present | Present |
| Example5 | 5 | 320000 | 1500000 | 4.7 | 154800 | Present | Present | Present |
| Example6 | 6 | 110000 | 1500000 | 13.6 | 149600 | Present | Present | Present |
| Example7 | 7 | 110000 | 1500000 | 13.6 | 152600 | Present | Present | Present |
| Example8 | 8 | 120000 | 1500000 | 12.5 | 158800 | Present | Present | Present |
| Example9 | 9 | 110000 | 1500000 | 13.6 | 155300 | Present | Present | Present |
| Example10 | 10 | 110000 | 1500000 | 13.6 | 162000 | Present | Present | Present |
| Example11 | 11 | 120000 | 1500000 | 12.5 | 156800 | Present | Present | Present |
| Example12 | 12 | 120000 | 1500000 | 12.5 | 156200 | Present | Present | Present |
| Example13 | 13 | 110000 | 1500000 | 13.6 | 149100 | Present | Present | Present |
| Example14 | 14 | 130000 | 1500000 | 11.5 | 157900 | Present | Present | Present |
| Example15 | 15 | 100000 | 1500000 | 15.0 | 148900 | Present | Present | Present |
| Example16 | 16 | 120000 | 1500000 | 12.5 | 156600 | Present | Present | Present |
| Example17 | 17 | 110000 | 1500000 | 13.6 | 145600 | Present | Present | Present |
| Example18 | 18 | 110000 | 1500000 | 13.6 | 168200 | Present | Present | Present |
| Example19 | 19 | 100000 | 1500000 | 15.0 | 153100 | Present | Present | Present |
| Example20 | 20 | 130000 | 1500000 | 11.5 | 142800 | Present | Present | Present |
| Example21 | 21 | 780000 | 1500000 | 1.9 | 149400 | Present | Present | Present |
| Example22 | 22 | 68700 | 1500000 | 21.8 | 157900 | Present | Present | Present |
| Example23 | 23 | 3200 | 1500000 | 468.8 | 161000 | Present | Present | Present |
| Example24 | 24 | 100000 | 8100000 | 81.0 | 219200 | Present | Present | Present |
| Example25 | 25 | 3400 | 19000 | 5.6 | 138600 | Present | Present | Present |
| Example26 | 26 | 110000 | 1500000 | 13.6 | 157200 | Present | Present | Present |
| Example27 | 27 | 110000 | 1500000 | 13.6 | 149500 | Present | Present | Present |
| Example28 | 28 | 110000 | 1500000 | 13.6 | 156800 | Present | Present | Present |
| Example29 | 29 | 8800 | 1500000 | 170.5 | 30200 | — | Present | Present |
| Example30 | 30 | 8800 | 1500000 | 170.5 | 30200 | — | Present | — |
| Comparative | Comparative1 | 62000 | 1500000 | 24.2 | 148800 | Present | Present | Present |
| Example1 | | | | | | | | |
| Comparative | Comparative2 | 110000 | 1500000 | 13.6 | 154900 | Present | Present | Present |
| Example2 | | | | | | | | |
| Comparative | Comparative3 | 110000 | 1500000 | 13.6 | 161000 | Present | Present | Present |
| Example3 | | | | | | | | |
| Comparative | Comparative4 | 120000 | 1500000 | 12.5 | 159200 | Present | Present | Present |
| Example4 | | | | | | | | |
| Comparative | Comparative5 | 190 | 9200000 | 48421.1 | 99400 | — | Present | — |
| Example5 | | | | | | | | |
| Comparative | Comparative6 | 110000 | — | — | 56000 | — | — | — |
| Example6 | | | | | | | | |

### Examples 2 to 28

In Examples 1, toner particles 2 to 28 were obtained in the same manner as in Example 1, except that the type and amount added of crystalline vinyl resin precursor, polymerizable monomer, and amorphous polyester resin used were changed as shown in Table 3.

Furthermore, external additives were added in the same manner as in Example 1 to obtain toners 2 to 28. The physical properties of the toners are shown in Tables 4-1 to 4-3, and the evaluation results are shown in Table 5.

### Example 29

### Preparation of Crystalline Resin Dispersion Liquid 1

Toluene: 300.0 parts
Crystalline vinyl resin precursor 1:100.0 parts

The above materials were weighed and mixed, and dissolved at 90° C. to obtain toluene solution 1.

Separately, 5.0 parts by mass of sodium dodecylbenzenesulfonate and 10.0 parts by mass of sodium laurate were added to 700.0 parts by mass of ion-exchanged water and heated and dissolved at 90° C. Next, the above toluene solution 1 and the aqueous solution were mixed, and stirred at 7000 rpm using a ultrahigh-speed stirrer T. K. Robomix (manufactured by Primix Corporation). Subsequent emulsification was performed at a pressure of 200 MPa using a high-pressure impact type disperser Nanomizer (manufactured by Yoshida Kikai Co., Ltd.). Then, toluene was removed using an evaporator, and the concentration was adjusted with ion-exchanged water to obtain crystalline resin dispersion liquid 1 with a concentration of fine particles of crystalline resin 1 of 20% by mass.

The 50% particle diameter (D50) of the fine particles of crystalline resin 1 based on volume distribution was measured using a dynamic light scattering particle diameter distribution analyzer Nanotrac UPA-EX150 (manufactured by Nikkiso Co., Ltd.), and was found to be 0.40 μm.

### Preparation of Amorphous Polyester Resin Dispersion Liquid 1

Toluene: 300.0 parts
Amorphous polyester resin 1:100.0 parts

The above materials were weighed and mixed, and then dissolved at 90° C. to obtain toluene solution 2.

Separately, 5.0 parts by mass of sodium dodecylbenzenesulfonate and 10.0 parts by mass of sodium laurate were added to 700.0 parts by mass of ion-exchanged water and heated and dissolved at 90° C. Next, the above toluene solution 2 and the aqueous solution were mixed, and stirred at 7000 rpm using the ultrahigh-speed stirrer T. K. Robomix (manufactured by Primix Corporation). Subsequent emulsification was performed at a pressure of 200 MPa using the high-pressure impact type disperser Nanomizer (manufactured by Yoshida Kikai Co., Ltd.). Then, toluene was removed using an evaporator, and the concentration was adjusted with ion-exchanged water to obtain amorphous polyester resin dispersion liquid 1 with a concentration of fine particles of amorphous polyester resin of 20% by mass.

The 50% particle diameter (D50) of the fine particles of amorphous polyester resin based on volume distribution was measured using a dynamic light scattering particle diameter distribution analyzer Nanotrac UPA-EX150 (manufactured by Nikkiso Co., Ltd.), and was found to be 0.38 μm.

### Preparation of Amorphous Vinyl Resin Dispersion Liquid 1

Styrene: 780.0 parts
n-Butyl acrylate: 220.0 parts
Dodecyl mercaptan: 6.0 parts

The above components were mixed and dissolved, and then dispersed and emulsified in a flask containing a solution prepared by dissolving 20.0 parts of anionic surfactant Newlex Paste H (manufactured by NOF Corporation) in 1300.0 parts of ion-exchanged water. While stirring for 10 min, 20.0 parts of ammonium persulfate dissolved in 200.0 parts of ion-exchanged water was added, and after nitrogen purging, the contents were heated to 70° C., and emulsion polymerization was carried out for 6 h. Thereafter, the reaction solution was cooled to room temperature, and the concentration was adjusted with ion-exchanged water to prepare amorphous vinyl resin dispersion liquid 1 with a concentration of fine particle of amorphous vinyl resin of 20% by mass.

The 50% particle diameter (D50) of the fine particles of amorphous vinyl resin based on volume distribution was measured using a dynamic light scattering particle diameter distribution analyzer Nanotrac UPA-EX150 (manufactured by Nikkiso Co., Ltd.), and was found to be 0.35 μm.

### Preparation of Release Agent Dispersion Liquid

DP18 (dipentaerythritol stearate ester wax, melting point 79° C., manufactured by Nisshin Oillio Co., Ltd.): 100.0 parts
Anionic surfactant Neogen RK (manufactured by Daiichi Kogyo Seiyaku Co., Ltd.): 5.0 parts
Deionized water: 395.0 parts

The above components were weighed and placed in a mixing container equipped with a stirring device, then heated to 90° C., and circulated through a ClearMix W-Motion (manufactured by M Technique Co., Ltd.) for 60 min of dispersion treatment. The dispersion treatment conditions were as follows:
Rotor outer diameter: 3 cm
Clearance: 0.3 mm
Rotor rotation speed: 19,000 rpm
Screen rotation speed: 19,000 rpm

After the dispersion treatment, the mixture was cooled to 40° C. under cooling treatment conditions of a rotor rotation speed of 1000 rpm, a screen rotation speed of 0 rpm, and a cooling rate of 10° C./min, thereby obtaining a release agent dispersion liquid with a concentration of fine particle of release agent of 20% by mass.

The 50% particle diameter (D50) of the fine particles of release agent based on volume distribution was measured using a dynamic light scattering particle diameter distribution analyzer Nanotrac UPA-EX150 (manufactured by Nikkiso Co., Ltd.), and was found to be 0.15 μm.

### Preparation of Colorant Dispersion Liquid

Colorant: 50.0 parts by mass
(Cyan pigment, manufactured by Dainichiseika Color & Chemicals Mfg. Co., Ltd.: Pigment Blue 15:3)
Anionic surfactant Neogen RK (manufactured by Daiichi Kogyo Seiyaku Co., Ltd.): 7.5 parts by mass
Ion-exchanged water: 442.5 parts by mass

The above components were weighed, mixed, and dissolved, and then dispersed for 1 h using a high-pressure impact type disperser, Nanomizer (manufactured by Yoshida Kikai Kogyo Co., Ltd.), to obtain a colorant dispersion liquid with a concentration of fine particles of colorant of 10% by mass.

The 50% particle diameter (D50) of the fine particles of colorant based on volume distribution was measured using a dynamic light scattering particle diameter distribution analyzer Nanotrac UPA-EX150 (manufactured by Nikkiso Co., Ltd.), and was found to be 0.20 μm.

### Production of Toner 29

Crystalline resin dispersion liquid 1:75.0 parts
Amorphous polyester resin dispersion liquid 1:25.0 parts
Amorphous vinyl resin dispersion liquid 1:200.0 parts
Release agent dispersion liquid: 45.0 parts
Colorant dispersion liquid: 65.0 parts
Deionized water: 160.0 parts

The above components were added to a round-bottomed stainless steel flask and mixed. Next, the mixture was dispersed for 10 min at 5000 rpm using a homogenizer Ultra-Turrax T50 (manufactured by IKA Corp.). After adding a 1.0% nitric acid aqueous solution to adjust the pH to 3.0, the mixture was heated to 58° C. in a heating water bath while stirring with a stirring blade and adjusting the rotation speed, as appropriate, to ensure thorough mixing.

The volume-average particle diameter of the formed aggregated particles was checked, as appropriate, using a Coulter Multisizer III. When aggregated particles with a number-average particle diameter of 4.0 μm were formed, 200.0 parts of crystalline resin dispersion liquid 1 was added, and the reaction was continued. When the number-average particle diameter reached 6.4 μm, the pH was adjusted to 9.0 using a 5% sodium hydroxide aqueous solution. Then, while continuing stirring, the mixture was heated to 75° C. The aggregated particles were then fused by holding the temperature at 75° C. for 1 h.

Afterward, cooling was performed to 45° C., followed by heat treatment for 5 h. Then, the mixture was cooled to 25° C., filtered and subjected to solid-liquid separation, and then washed with ion-exchanged water. After washing, drying was performed using a vacuum dryer to obtain toner particles 29 with a number-average particle diameter of 6.5 μm.

Toner 29 was obtained by performing the same external addition to toner particles 29 as in Example 1. The physical properties of toner 29 are shown in Tables 4-1 to 4-3, and the evaluation results are shown in Table 5.

### Example 30

### Preparation of Amorphous Polyester Resin Dispersion Liquid 2

Toluene: 300.0 parts
Amorphous polyester resin 1:100.0 parts

The above materials were weighed and mixed, and then dissolved at 90° C. to obtain toluene solution 3.

Separately, 10.0 parts by mass of sodium dodecylbenzenesulfonate and 20.0 parts by mass of sodium laurate were added to 700.0 parts by mass of ion-exchanged water and heated and dissolved at 90° C. Next, the above toluene solution 3 and the aqueous solution were mixed, and stirred at 7000 rpm using the ultrahigh-speed stirrer T. K. Robomix (manufactured by Primix Corporation). Subsequent emulsification was performed at a pressure of 200 MPa using the high-pressure impact type disperser Nanomizer (manufactured by Yoshida Kikai Co., Ltd.). Then, toluene was removed using an evaporator, and the concentration was adjusted with ion-exchanged water to obtain amorphous polyester resin dispersion liquid 2 with a concentration of fine particles of amorphous polyester resin of 20% by mass.

The 50% particle diameter (D50) of the fine particles of amorphous polyester resin based on volume distribution was measured using a dynamic light scattering particle diameter distribution analyzer Nanotrac UPA-EX150 (manufactured by Nikkiso Co., Ltd.), and was found to be 0.14 μm.

### Preparation of Amorphous Vinyl Resin Dispersion Liquid 2

Styrene: 780.0 parts
n-Butyl acrylate: 220.0 parts
Dodecyl mercaptan: 6.0 parts

The above components were mixed and dissolved, and then dispersed and emulsified in a flask containing a solution prepared by dissolving 40.0 parts of anionic surfactant Newlex Paste H (manufactured by NOF Corporation) in 1300.0 parts of ion-exchanged water. While stirring for 10 min, 20.0 parts of ammonium persulfate dissolved in 200.0 parts of ion-exchanged water was added, and after nitrogen purging, the contents were heated to 70° C., and emulsion polymerization was carried out for 6 h. Thereafter, the reaction solution was cooled to room temperature, and the concentration was adjusted with ion-exchanged water to prepare amorphous vinyl resin dispersion liquid 2 with a concentration of fine particle of amorphous vinyl resin of 20% by mass.

The 50% particle diameter (D50) of the fine particles of amorphous vinyl resin based on volume distribution was measured using a dynamic light scattering particle diameter distribution analyzer Nanotrac UPA-EX150 (manufactured by Nikkiso Co., Ltd.), and was found to be 0.13 μm.

### Production of Toner 30

Crystalline resin dispersion liquid 1:125.0 parts
Amorphous polyester resin dispersion liquid 2:17.5 parts
Amorphous vinyl resin dispersion liquid 2:175.0 parts
Release agent dispersion liquid: 45.0 parts
Colorant dispersion liquid: 65.0 parts
Deionized water: 160.0 parts

The above components were added to a round-bottomed stainless steel flask and mixed. Next, the mixture was dispersed for 10 min at 5000 rpm using a homogenizer Ultra-Turrax T50 (manufactured by IKA Corp.). After adding a 1.0% nitric acid aqueous solution to adjust the pH to 3.0, the mixture was heated to 58° C. in a heating water bath while stirring with a stirring blade and adjusting the rotation speed, as appropriate, to ensure thorough mixing.

The volume-average particle diameter of the formed aggregated particles was checked, as appropriate, using a Coulter Multisizer III. When aggregated particles with a number-average particle diameter of 4.0 μm were formed, 100.0 parts of crystalline resin dispersion liquid 1 was added, and the reaction was continued. When the number-average particle diameter reached 6.0 μm, 75.0 parts of amorphous vinyl resin dispersion liquid 2 and 7.5 parts of amorphous polyester resin dispersion liquid 2 were added, and the reaction was further continued. When the number-average particle diameter reached 6.3 μm, the pH was adjusted to 9.0 using a 5% sodium hydroxide aqueous solution. Then, while continuing stirring, the mixture was heated to 75° C. The aggregated particles were then fused by holding the mixture at 75° C. for 1 h.

Afterward, cooling was performed to 45° C., followed by heat treatment for 5 h.

Then, the mixture was cooled to 25° C., filtered and subjected to solid-liquid separation, and then washed with ion-exchanged water. After washing, drying was performed using a vacuum dryer to obtain toner particles 30 with a number-average particle diameter of 6.4 μm.

Toner 30 was obtained by performing the same external addition to toner particles 30 as in Example 1. The physical properties of toner 30 are shown in Tables 4-1 to 4-3, and the evaluation results are shown in Table 5.

### Comparative Examples 1 to 4

Comparative toner particles 1 to 4 were obtained in the same manner as in Example 1, except that the type and amount of the crystalline vinyl resin precursor, polymerizable monomer, and amorphous polyester resin used were changed as shown in Table 3.

Furthermore, comparative toners 1 to 4 were obtained by performing the same external addition as in Example 1. The physical properties of the toners are shown in Tables 4-1 to 4-3, and the evaluation results are shown in Table 5.

### Comparative Example 5

### Preparation of Crystalline Vinyl Resin Precursor 10

The following materials were placed in a reaction container equipped with a reflux condenser, a stirrer, a thermometer, and a nitrogen introduction tube under a nitrogen atmosphere.
Toluene: 100.0 parts
Behenyl acrylate: 100.0 parts
2,2′-Azobis(2,4-dimethylvaleronitrile) (V-65, manufactured by Wako Pure Chemical Industries, Ltd.): 10.0 parts

The contents of the container were stirred at 200 rpm and heated to 60° C. for 12 h. Then, the mixture was heated to 95° C. and stirred for 8 h, and the solvent was removed to obtain crystalline vinyl resin precursor 10. The obtained crystalline vinyl resin precursor 10 had a weight-average molecular weight of 22,000.

### Preparation of Shell Resin 1

The following materials were placed in a reaction container equipped with a reflux condenser, a stirrer, a thermometer, and a nitrogen introduction tube under a nitrogen atmosphere.
Styrene: 80.0 parts
n-Butyl acrylate: 20.0 parts
Methyl methacrylate: 3.0 parts
Methacrylic acid: 1.5 parts
Toluene: 100.0 parts
t-Butyl peroxypivalate: 10.0 parts

The contents of the container were stirred at 200 rpm and heated to 80° C. for 10 h. Then, the mixture was heated to 95° C. and stirred for 8 h, and the solvent was removed to obtain shell resin 1.

### Production of Comparative Toner 5

Crystalline vinyl resin precursor 10:84.0 parts
Styrene: 100.0 parts
n-Butyl acrylate: 25.0 parts
Shell resin 1:10.0 parts
Pigment Blue 15:3 (manufactured by Dainichiseika Color & Chemicals Mfg. Co., Ltd.): 6.0 parts
Aluminum salicylate compound: 1.0 part
(Bontron E-88: manufactured by Orient Chemical Industries Co., Ltd.)
Release agent: paraffin wax: 9.0 parts
(HNP-51: manufactured by Nippon Seiro Co., Ltd., melting point 74° C.)
Toluene (SP value 8.8): 100.0 parts

The above materials were dispersed using an attritor (manufactured by Mitsui Miike Chemical Machinery Co., Ltd.) to obtain a polymerizable monomer composition.

Furthermore, 800 parts of ion-exchanged water and 15.5 parts of tricalcium phosphate were added to a container equipped with a high-speed stirring device TK-Homomixer (manufactured by Tokushu Kika Kogyo Co., Ltd.), the rotation speed was adjusted to 15,000 rpm, and the mixture was heated to 70° C. to form a dispersion medium system.

The above polymerizable monomer composition was heated to 60° C., and after confirming the dissolution of crystalline vinyl resin precursor 10, 6.0 parts of t-butyl peroxypivalate, as a polymerization initiator, was added, and the resulting composition was introduced into the dispersion medium system. A granulation step was performed for 20 min while maintaining 12,000 rpm with the high-speed stirring device. Thereafter, the stirring device was changed from the high-speed stirring device to a propeller stirring blade, and polymerization was performed for 10.0 h while maintaining the liquid temperature in the container at 70° C. with stirring at 150 rpm. After the polymerization step, the liquid temperature was raised to 95° C. to remove unreacted polymerizable monomers and toluene.

After completion of the polymerization, the obtained dispersion liquid of polymer particles was cooled to 20° C. at an average rate of 0.6° C./min while stirring, and ion-exchanged water was added to adjust the concentration of polymer particles in the dispersion liquid to 20% by mass, thereby obtaining a toner particle dispersion liquid.

The toner particle dispersion liquid was stirred for 2 h at 25° C. while adding hydrochloric acid until the pH reached 1.5. Furthermore, after thoroughly washing with ion-exchanged water, filtration, drying, and classification were performed to obtain comparative toner particles 5.

Next, 100.0 parts of the comparative toner particles 5 were weighed out, and external additives were added in the same manner as in Example 1 to obtain comparative toner 5. The physical properties of the obtained comparative toner 5 are shown in Tables 4-1 to 4-3, and the evaluation results are shown in Table 5.

### Comparative Example 6

### Production of Comparative Toner 6

Monomer composition: 100.0 parts
(The monomer composition is a mixture of following behenyl acrylate, methacrylonitrile, and styrene in the following proportions)
(Behenyl acrylate: 67.0 parts)
(Methacrylonitrile: 22.0 parts)
(Styrene: 11.0 parts)
Pigment Blue 15:3: 6.5 parts
Aluminum di-t-butylsalicylate: 1.0 part
Excerex 30050B (melting point 91° C., manufactured by Mitsui Chemicals, Inc.): 10.0 parts
Toluene: 100.0 parts

A mixture consisting of the above materials was prepared. This mixture was placed in an attritor (manufactured by Nippon Coke & Engineering Co., Ltd.) and dispersed for 2 h at 200 rpm using zirconia beads having a diameter of 5 mm to obtain a raw material dispersion liquid.

Meanwhile, 735.0 parts of ion-exchanged water and 16.0 parts of trisodium phosphate (dodecahydrate) were added to a container equipped with a high-speed stirrer (Homomixer, manufactured by Primix Corporation) and a thermometer, and the temperature was raised to 60° C. while stirring at 12,000 rpm. Then, an aqueous calcium chloride solution prepared by dissolving 9.0 parts of calcium chloride (dihydrate) in 65.0 parts of ion-exchanged water was added, and the mixture was stirred at 12,000 rpm for 30 min while maintaining the temperature at 60° C. Then, 10% hydrochloric acid was added to adjust the pH to 6.0, thereby obtaining an aqueous medium containing a dispersion stabilizer.

Next, the raw material dispersion liquid was transferred to a container equipped with a stirring device and a thermometer, and the temperature was raised to 60° C. while stirring at 100 rpm. A total of 8.0 parts of t-butyl peroxy pivalate (Perbutyl PV, manufactured by NOF Corporation) was added as a polymerization initiator, and after stirring at 100 rpm for 5 min while maintaining 60° C., the mixture was added to the aqueous medium being stirred at 12,000 rpm using the high-speed stirring device. Stirring was continued at 12,000 rpm using the high-speed stirring device for 20 min while maintaining 60° C. to obtain a granulation liquid.

The granulation liquid was transferred to a reaction container equipped with a reflux condenser, a stirrer, a thermometer, and a nitrogen introduction tube, and the temperature was raised to 70° C. while stirring at 150 rpm under a nitrogen atmosphere. Polymerization reaction was carried out at 70° C. for 10 h while stirring at 150 rpm. Afterward, the reflux condenser was removed from the reaction container, and the temperature of the reaction solution was raised to 95° C. Toluene was then removed by stirring at 150 rpm for 5 h while maintaining 95° C., thereby obtaining a toner particle dispersion liquid.

The obtained toner particle dispersion liquid was cooled to 20° C. while stirring at 150 rpm. While maintaining stirring, dilute hydrochloric acid was added until the pH reached 1.5 to dissolve the dispersion stabilizer. The solid matter was filtered, thoroughly washed with ion-exchanged water, and then vacuum-dried at 40° C. for 24 h to obtain comparative toner particles 6 containing the monomer composition.

A total of 100.0 parts of comparative toner particles 6 were weighed out, and external additives were added in the same manner as in Example 1 to obtain comparative toner 6. The physical properties of the obtained comparative toner 6 are shown in Tables 4-1 to 4-3, and the evaluation results are shown in Table 5.

### Toner Evaluation Methods

### <1> Evaluation of Low-Temperature Fixability (Blank Dots)

A process cartridge filled with toner was allowed to stand at 25° C. and 40% RH for 48 h. Using an LBP-712Ci modified to operate even with the fixing device removed, an unfixed image of an image pattern consisting of 10 mm×10 mm square images evenly arranged in a 9-point array across the entire transfer paper was output. The toner laid-on level on the transfer paper was set to 0.90 mg/cm², and the fixing start temperature was evaluated. The transfer paper used was LTR paper (“Classic Crest paper”: 105 g/m², manufactured by Neenah Paper Co.).

The fixing device used was an external fixing device obtained by removing the fixing device of LBP-712Ci and modifying it to operate outside the laser beam printer. Fixing with the external fixing device was performed by raising the fixing temperature in 5° C. increments from 90° C., under conditions of a 15° C. environment, process speed A: 300 mm/sec, and process speed B: 330 mm/sec.

The fixed image was visually inspected, the lowest temperature at which no blank dots (partial toner dropout from the image) occurred was defined as the fixing start temperature, and the low-temperature fixability was evaluated. The evaluation results are shown in Table 5.

### Evaluation Criteria

A: Fixing start temperature is 100° C. or lower
B: Fixing start temperature is from 105° C. to 110° C.
C: Fixing start temperature is from 115° C. to 120° C.
D: Fixing start temperature is 125° C. or higher

### <2> Evaluation of Mottling

A solid image was output using the modified machine described above, and mottling was evaluated. As the transfer paper, LTR paper (“Classic Crest paper”: 105 g/m², manufactured by Neenah Paper Co.) was used. Image density was measured with a color reflection densitometer (X-RITE 404, manufactured by X-Rite, Inc.). The density was measured at 30 arbitrary points within the development area, and the evaluation was performed as follows based on the image density difference obtained from the maximum density and minimum density.
A: Image density difference (maximum density−minimum density) is less than 0.05.
B: Image density difference (maximum density−minimum density) is 0.05 or more and less than 0.10.
C: Image density difference (maximum density−minimum density) is 0.10 or more and less than 0.15.
D: Image density difference (maximum density−minimum density) is 0.15 or more.

### <3> Heat-Resistant Storage Stability

To evaluate the stability during storage, heat-resistant storage stability was evaluated. A total of 5 g of toner was placed in a 100 ml resin cup and allowed to stand for 10 days in an environment of 50° C. and 40% RH. After that, the degree of toner aggregation was measured as follows and evaluated according to the following criteria.

The measuring device used was obtained by connecting a digital display type vibration meter “DigiVibro MODEL 1332A” (manufactured by Showa Sokki Co., Ltd.) to the side surface portion of the vibrating table of “Powder Tester” (manufactured by Hosokawa Micron Corporation). A sieve with a mesh size of 38 μm (400 mesh), a sieve with a mesh size of 75 μm (200 mesh), and a sieve with a mesh size of 150 μm (100 mesh) were stacked in that order from the bottom on the vibrating table of the powder tester. The measurement was performed at 23° C. and 60% RH in the following manner.
(1) The vibration amplitude of the vibration table was pre-adjusted so that the displacement value of the digital display type vibration meter was 0.60 mm (peak-to-peak).
(2) The toner that had been allowed to stand for 10 days as described above was allowed to stand for 24 h in an environment of 23° C. and 60% RH. A total of 5.00 g of this toner was accurately weighed and gently placed on the uppermost sieve with a mesh opening of 150 μm.
(3) After vibrating the sieve for 15 sec, the mass of the toner remaining on each sieve was measured, and the degree of aggregation was calculated based on the following formula. The evaluation results are shown in Table 5.

Degree of aggregation (%)={(Sample mass(g) on the sieve with a mesh opening of 150 μm)/5.00(g)}×100+{(Sample mass(g) on the sieve with a mesh opening of 75 μm)/5.00(g)}×100×0.6+{(Sample mass(g) on the sieve with a mesh opening of 38 μm)/5.00(g)}×100×0.2

### Evaluation Criteria

A: Degree of aggregation is less than 10.0%
B: Degree of aggregation is 10.0% or more and less than 15.0%.
C: Degree of aggregation is 15.0% or more and less than 20.0%.
D: Degree of aggregation is 20.0% or more

TABLE 5

| | | | | | | | | Heat-resistant | |
|---|---|---|---|---|---|---|---|---|---|
| | | Low-temperature | | Low-temperature | | | | storage stability | |
| | | fixability, process | | fixability, process | | | | Degree of | |
| | | speed A | | speed B | | Mottling | | aggregation | |
| | | Fixing start | | Fixing start | | Image | | after 10 days | |
| | Toner | temperature | | temperature | | density | | at 50° C. | |
| | No. | (° C.) | Evaluation | (° C.) | Evaluation | difference | Evaluation | (%) | Evaluation |
| Example1 | 1 | 100 | A | 100 | A | 0.02 | A | 3.9 | A |
| Example2 | 2 | 95 | A | 95 | A | 0.03 | A | 12.8 | B |
| Example3 | 3 | 90 | A | 90 | A | 0.02 | A | 18.9 | C |
| Example4 | 4 | 110 | B | 110 | B | 0.03 | A | 4.0 | A |
| Example5 | 5 | 120 | C | 120 | C | 0.02 | A | 3.8 | A |
| Example6 | 6 | 100 | A | 100 | A | 0.07 | B | 3.8 | A |
| Example7 | 7 | 100 | A | 100 | A | 0.12 | C | 3.9 | A |
| Example8 | 8 | 100 | A | 100 | A | 0.02 | A | 3.9 | A |
| Example9 | 9 | 105 | B | 105 | B | 0.02 | A | 6.7 | A |
| Example10 | 10 | 115 | C | 115 | C | 0.03 | A | 7.9 | A |
| Example11 | 11 | 100 | A | 100 | A | 0.07 | B | 6.6 | A |
| Example12 | 12 | 100 | A | 100 | A | 0.10 | C | 7.7 | A |
| Example13 | 13 | 100 | A | 100 | A | 0.02 | A | 6.8 | A |
| Example14 | 14 | 115 | C | 115 | C | 0.12 | C | 7.9 | A |
| Example15 | 15 | 95 | A | 95 | A | 0.04 | A | 9.8 | A |
| Example16 | 16 | 100 | A | 105 | B | 0.11 | C | 3.5 | A |
| Example17 | 17 | 100 | A | 105 | B | 0.12 | C | 3.5 | A |
| Example18 | 18 | 100 | A | 105 | B | 0.02 | A | 3.5 | A |
| Example19 | 19 | 105 | B | 110 | B | 0.02 | A | 3.4 | A |
| Example20 | 20 | 100 | A | 100 | A | 0.13 | C | 9.2 | A |
| Example21 | 21 | 100 | A | 100 | A | 0.02 | A | 3.7 | A |
| Example22 | 22 | 100 | A | 100 | A | 0.02 | A | 4.0 | A |
| Example23 | 23 | 95 | A | 95 | A | 0.03 | A | 5.2 | A |
| Example24 | 24 | 100 | A | 100 | A | 0.02 | A | 3.7 | A |
| Example25 | 25 | 95 | A | 95 | A | 0.04 | A | 5.7 | A |
| Example26 | 26 | 100 | A | 105 | B | 0.02 | A | 4.7 | A |
| Example27 | 27 | 100 | A | 105 | B | 0.02 | A | 6.6 | A |
| Example28 | 28 | 105 | B | 115 | C | 0.02 | A | 8.1 | A |
| Example29 | 29 | 100 | A | 100 | A | 0.02 | A | 14.1 | B |
| Example30 | 30 | 120 | C | 120 | C | 0.14 | C | 8.4 | A |
| Comparative | Comparative1 | 90 | A | 90 | A | 0.02 | A | 23.3 | D |
| example1 | | | | | | | | | |
| Comparative | Comparative2 | 100 | A | 100 | A | 0.16 | D | 3.8 | A |
| example2 | | | | | | | | | |
| Comparative | Comparative3 | 125 | D | 125 | D | 0.10 | C | 8.4 | A |
| example3 | | | | | | | | | |
| Comparative | Comparative4 | 100 | A | 100 | A | 0.15 | D | 9.7 | A |
| example4 | | | | | | | | | |
| Comparative | Comparative5 | 125 | D | 125 | D | 0.17 | D | 5.2 | A |
| example5 | | | | | | | | | |
| Comparative | Comparative6 | 100 | A | 100 | A | 0.20 | D | 15.8 | C |
| example6 | | | | | | | | | |

According to this disclosure, it is possible to provide a toner that exhibits excellent low-temperature fixability even under conditions where the toner laid-on level on rough paper is large in a low-temperature environment, and furthermore, is less prone to mottling on rough paper.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055528, filed Mar. 28, 2025, which is hereby incorporated by reference herein in its entirety.

What is claimed is:

1. A toner comprising a toner particle comprising a binder resin, wherein
the binder resin comprises a crystalline resin and an amorphous resin;
the toner has a number-average particle diameter of 4.0 μm to 10.0 μm;
the crystalline resin comprises a crystalline vinyl resin having a monomer unit (a) represented by a following formula (1);
in differential scanning calorimetry (DSC) using the toner as a sample, a melting point peak derived from the crystalline vinyl resin is observed in a range of 50.0° C. to 80.0° C.; and
when a cross-section of the toner is observed by using a scanning transmission electron microscope,
(i) the cross-section of the toner particle has a phase separation structure comprising a crystalline phase comprising the crystalline resin as a main component and an amorphous phase comprising the amorphous resin as a main component, and
a proportion of an area of the amorphous phase in the cross-section of the toner particle is at least 15.0% by area; and
(ii) when a region from the toner particle surface to 500 nm inward of the toner particle is defined as region A, and a region other than the region A is defined as region B,
a proportion of an area of the crystalline phase in the region A is at least 60.0% by area, and
a proportion of the area of the amorphous phase in the region B is 1.5 times or more the proportion of the area of the amorphous phase in the region A: 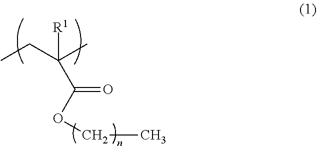
where, in formula (1), R¹ represents a hydrogen atom or a methyl group, and n represents an integer 15 to 35.

2. The toner according to claim 1, wherein
the amorphous resin comprises an amorphous vinyl resin, and
a content ratio of the amorphous vinyl resin in the amorphous resin is at least 50.0% by mass.

3. The toner according to claim 2, wherein a content ratio of the amorphous vinyl resin in the binder resin is 10.0% by mass to 75.0% by mass.

4. The toner according to claim 1, wherein a content ratio of the crystalline vinyl resin in the binder resin is 5.0% by mass to 70.0% by mass.

5. The toner according to claim 1, wherein a storage elastic modulus of the crystalline vinyl resin at 80° C. is 1.0×10³ Pa to 1.0×10⁶ Pa.

6. The toner according to claim 1, wherein
the amorphous resin comprises an amorphous vinyl resin, and
a storage elastic modulus of the amorphous vinyl resin at 80° C. is 1.0×10⁴ Pa to 1.0×10⁷ Pa.

7. The toner according to claim 1, wherein
the amorphous resin comprises an amorphous vinyl resin, and
a storage elastic modulus of the amorphous vinyl resin at 80° C. is 1.0 times or more a storage elastic modulus of the crystalline vinyl resin at 80° C.

8. The toner according to claim 1, wherein
the amorphous resin comprises an amorphous polyester resin, and
the amorphous polyester resin is a condensation polymer of a monovalent or divalent carboxylic acid and a monohydric or dihydric alcohol.

9. The toner according to claim 8, wherein a content ratio of the amorphous polyester resin in the binder resin is 1.0% by mass to 15.0% by mass.

10. The toner according to claim 8, wherein the amorphous polyester resin has a monomer unit represented by a following formula (2): 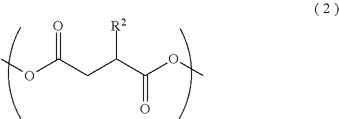
where, in formula (2), R² represents an alkyl group or alkenyl group having 8 to 16 carbon atoms.

11. The toner according to claim 8, wherein
when a cross-section of the toner is observed by using a scanning transmission electron microscope,
the toner particle has a shell of the amorphous polyester resin,
the toner particle has a domain-matrix structure composed of domains of the amorphous phase and a matrix of the crystalline phase, and
the toner particle has at least one domain having an area of 10.0% by area with respect to a total area of the cross-section of the toner particle.
